(19) United States
(12) Patent Application Publication
(10) Pub. No.: US 2017/0242936 A9
(43) Pub. Date: Aug. 24, 2017

(54) Symmetry Graphical Method in Thermodynamics

(71) Applicant: Zhen-Chuan Li, New York, NY (US)

(72) Inventor: Zhen-Chuan Li, New York, NY (US)

(21) Appl. No.: 14/815,827

(22) Filed: Jul. 31, 2015

(51) Int. Cl. G06F 17/50; G06F 17/10

(52) U.S. Cl. CPC G06F 17/5009; G06F 17/10

(57) ABSTRACT

From a mathematical point of view, thermodynamic properties behave like multi-variable functions and can usually be differentiated and integrated. Many thermodynamic equations with similar function forms could be resolved into families. The members of a family with ‘patterned self-similarity’ can precisely be defined as symmetrical functions, which are left invariant not only in function form, but also in variable nature and relationship under symmetrical operations. The simplest and must evident symmetrical operations happen in the geometrical symmetry of a physical object. Therefore it is possible to employ geometry to reveal symmetry in thermodynamics, incorporate the symmetry to develop a coherent and complete structure (a diagram or model) of thermodynamic variables, and facilitate the subject with the symmetry. In this invented method you can find out that (1) A variety of (totally forty four) thermodynamic variables are properly arranged at vertices of an extended concentric multi-polyhedron based on their physical meanings. (2) Numerous (more than three hundreds) equations of twelve families can concisely be depicted by overlapping specific movable graphical patterns on fixed diagrams through symmetrical operations. (3) Any desired partial derivatives can graphically be derived in terms of several available quantities like getting any destinations on a map.

### DETAILED DESCRIPTION OF THE INVENTION

### Specification of the Invention

### I. Introduction

A theoretical interpretation of thermodynamics being a science of symmetry was proposed by Herbert Callen. While an integration of the entire structure into a coherent and complete exposition of thermodynamics was not undertaken, since it would require repetition of an elaborate formalism with which the reader presumably is familiar ^{[1, 2]}. On the other hand, many works, such as an important class of thermodynamic equations being resolved with ‘standard form’ into families ^{[3, 4]} and expressed by geometrical diagrams (square ^{[5]}, cuboctahedron ^{[6]}, concentric multi-circle ^{[7]}, cube ^{[8]}, and Venn diagram ^{[9]}) have revealed symmetry existing in thermodynamics, a keen sense of which is helpful to any learners of the rigorous subject.

From a mathematical point of view, thermodynamic properties behave like multi-variable functions and can usually be differentiated and integrated. Many thermodynamic equations with similar function forms could be resolved into families. The members of a family with ‘patterned self-similarity’ can precisely be defined as symmetrical functions, which are left invariant not only in function form, but also in variable nature and relationship under symmetrical operations.

The simplest and most evident symmetrical operations happen in the geometric symmetry of a physical object. Therefore it is possible to employ geometry to reveal symmetry in thermodynamics, incorporate the symmetry to develop a coherent and complete structure (a diagram or model) of thermodynamic variables, and facilitate the subject with the symmetry.

In this specification, you will read: (1) How can we properly arrange a variety of (totally forty four) thermodynamic variables in a 3-D diagram based on their physical meanings? (2) How can we concisely depict numerous (more than three hundreds) thermodynamic equations through symmetrical operations? (3) How can we graphically distinguish similar and quite confused partial derivatives? (4) How can we derive any desired partial derivatives in terms of several available quantities on the spot? (5) How can we verify specific symmetry in thermodynamics?

### II. An Extended Concentric Multi-Polyhedron Diagram

For a single component one-phase system, a variety of thermodynamic variables, such as natural variables, thermodynamic potentials, first and second order partial derivatives, can be properly arranged in a 3-D diagram based on their physical meanings as follows:
1. Natural variables: Three conjugate (intensive˜extensive) pairs of natural variables, i.e. temperature (T)˜entropy (S), pressure (P)˜volume (V), and chemical potential (μ)˜amount of the species (N), are arranged at vertices of a small octahedron with the Cartesian coordinates: T[1,0,0]˜S[−1,0,0], P[0,−1,0]˜V[0,1,0], and μ[0, 0,1]˜N[0,0,−1].
2. Thermodynamic potentials: In order to exhibit a close relationship between each thermodynamic potential and its three correlated natural valuables, let four conjugate pairs of thermodynamic potentials {internal energy U(S, V, N)˜Φ(7, P, μ), enthalpy H(S, P, N)˜grand canonical potential Ω(T, V, μ), Gibbs free energy G(T, P, N)˜ψ(S, V, μ), Helmholtz free energy A(T, V, N)˜χ(S, P, μ)} be located at opposite ends of the four diagonals of a cube with the Cartesian coordinates: U[−1, 1, −1]˜Φ[1, −1, 1], H[−1, −1, −1]˜Ω[1, 1, 1], G[1, −1, −1]˜ψ[−1, 1, 1] and A[1, −1]˜χ[−1, −1, 1].
3. First order partial derivatives: Six first order partial derivatives are almost same as the six natural variables except for some of them that hold a negative sign like −S, −P and −N. Let the six first order partial derivatives (T, −S, −P, V, μ, and −N) be located at vertices of a large octahedron with the Cartesian coordinates: T[3,0,0], −S[−3,0,0], −P[0, −3,0], V[0,3,0], μ[0,0,3] and −N[0,0, −3], where the negative sign of those variables indicates that they physically seek a maximum, rather than a minimum, as a criterion for spontaneous changes and equilibriums.
4. Second order partial derivatives: Second order partial derivatives of thermodynamic potentials generally describe material properties, such as isobaric and isochoric heat capacity (C_{R} and C_{V}), isobaric thermal expansion coefficient (α) and isothermal compressibility (κ_{T} or β). Other twenty two C_{P} type variables were symmetrically invented based on the C_{P}'s definition. Let the twenty four C_{P} type variables (C_{PN}, C_{VN}, O_{PN}, O_{VN}, J_{TN}, J_{SN}, R_{TN}, R_{SN}, C_{Pμ}, C_{Vμ}, O_{Pμ}, O_{Vμ}, J_{Tμ}, J_{Sμ}, R_{Tμ}, R_{Sμ}, Λ_{PT}, Λ_{VT}, Γ_{PT}, Γ_{VT}, Λ_{PS}, Λ_{VS}, Γ_{PS}, & Γ_{VS}) properly locate at twenty four vertices of an extended polyhedron, ‘rhombicuboctahedron’, where they are close to their correlated thermodynamic potential and natural variables. Their Cartesian coordinates are all permutations of <±h, ±h, ±k>, where h equals one and half unit (h=1.50), and k is larger than h by (1+\sqrt{2}) times (k=3.62).

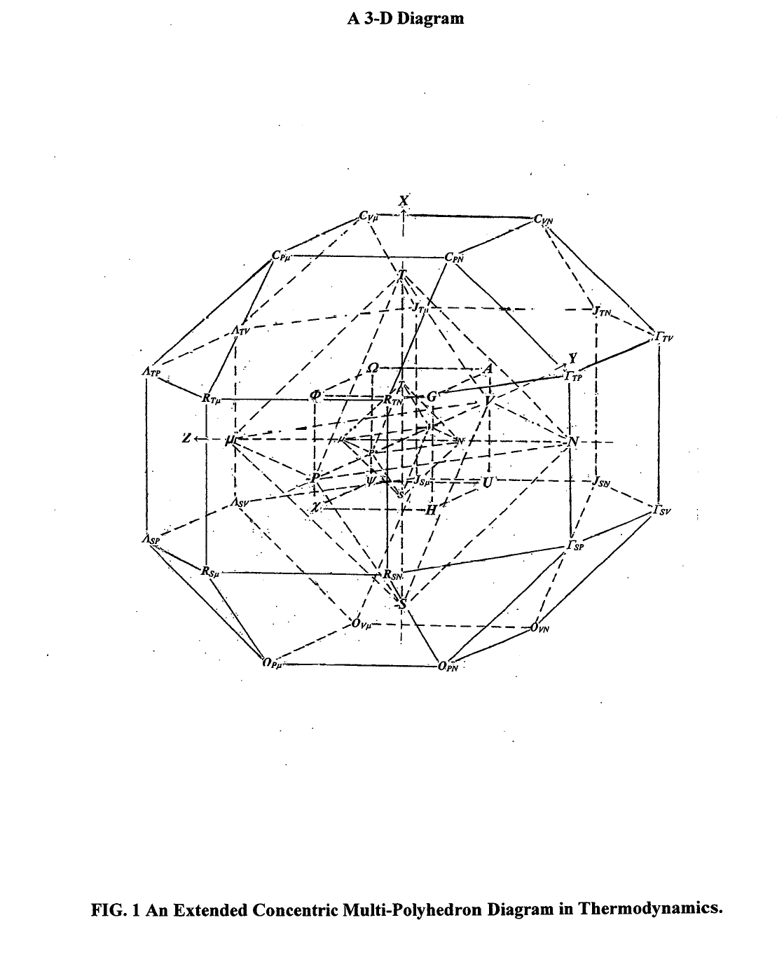

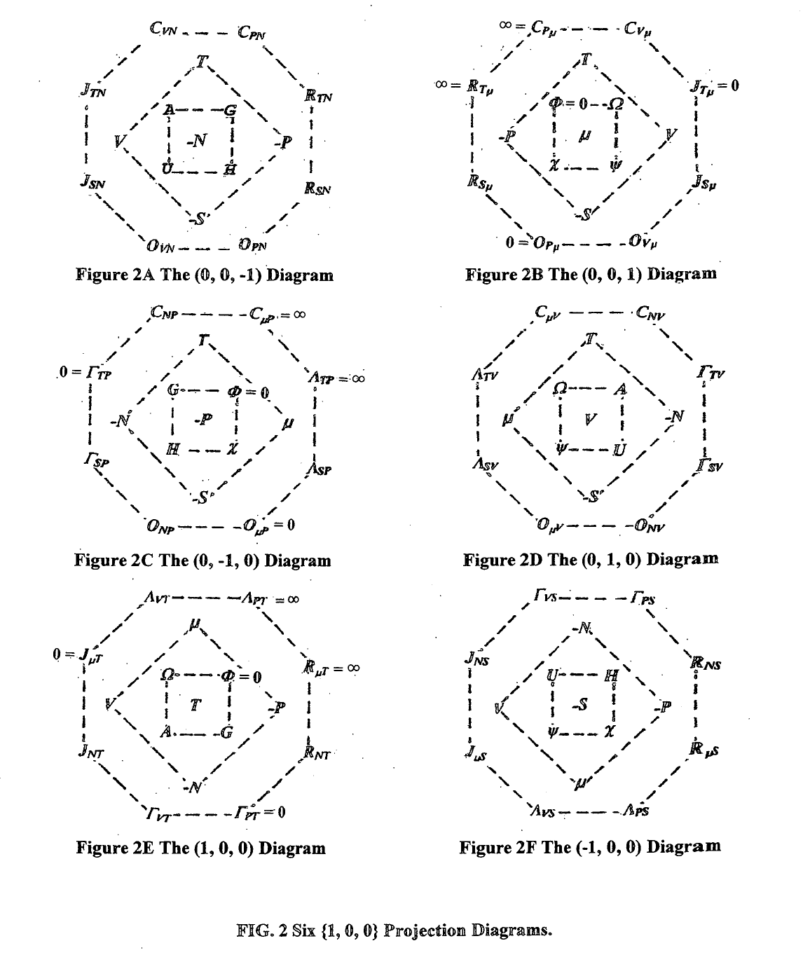

Physically, such a scheme to arrange different kinds of thermodynamic variables at the vertices of an extended concentric multi-polyhedron shown in FIG. 1, whose 3-D coordinates are summarized in Supporting Material-I, corresponds to the Ehrenfest's scheme to classify phase transitions.
5. Simplify the 3-D diagram: In such a concentric multi-polyhedron diagram (a cube is sandwiched in between two octahedrons, and surrounded by a rhombicuboctahedron), symbols of the variables in the two similar octahedrons are almost the same except for −S, −P and −N. The variables with the negative sign (−S, −P and −N) in the large octahedron mean negative (−), and stand for only the first order partial derivatives, not the natural variables. Other variables without a sign in front of them mean positive (+), and can stand for either one. Therefore, it is possible to simplify two octahedrons into the large one if the signs of those variables could be taken into account by a specific way, which will be described later.
6. Resolve the 3-D diagram into 2-D diagrams: Carrying out symmetrical operations on the 3-D diagram is complicated and quite difficult, whereas doing so on a 2-D diagram will be much easier instead. The simplified concentric three layer polyhedron diagram (the thermodynamic cube, large octahedron and rhombicubuctahedron) could be resolved into six 2-D {1 0 0} projection diagrams, which are shown in FIG. 2 (FIG. 2A to FIG. 2F), and each 2-D diagram consists of two squares and an octagon.

In practically doing so, the variables located at the vertices of the multi-polyhedron are parallel projected from the central plane outward along the six first order partial derivative variable's (−N, μ, −P, V, T, and −S), i. e. six <1, 0, 0>, directions on six {1, 0, 0} planes respectively, while the most outside four C_{P} type variables are omitted without any disadvantage in order to agree with the familiar concentric multi-circular diagram ^{[7]}. For example, Γ_{PT}, Γ_{VT}, Γ_{PS} and Γ_{VS} are missed on the FIG. 2A.

On the other hand, theoretically any vertices of the 3-D concentric multi-polyhedron, whose Cartesian coordinates are x, y and z, can be projected by the matrix method ^{[10]} on a desired projection plane, (h k l), and the locations of these vertices on the 2-D projection diagram can be expressed by the coordinates of the corresponding 2-D vectors, V:

V=(xσ₁₁+γσ₁₂+zσ₁₃)n₁^{o}+(xσ₂₁+yσ₂₂+zσ₂₃)n₂^{o},

where n₁^{o} and n₂^{o} are two mutually orthogonal unit vectors in the projected plane and correspond to the normal's of two planes, (h₁ k₁ l₁) and (h₂ k₂ l₂); σᵢⱼ are elements of the transformation matrix, i.e.

σ₁₁=d′₁₁h₁. σ₁₂=d′₁₁k₁. σ₁₃=d′₁₁l₁.

σ₂₁=d′₂₂h₂. σ₂₂=d′₂₂k₂. σ₂₃=d′₂₂l₂,

where d′ᵢᵢ is given by

$${d}_{ii}^{′} = \frac{1}{\sqrt{{h}_{i}^{2} + {k}_{i}^{2} + {l}_{i}^{2}}} , ( i = 1 , 2 )$$

The six {1 0 0} projection diagrams exhibiting the four-fold rotation and mirror symmctrics (C₄ and σ) are given in FIG. 2, which consists of ‘−N’-centered FIG. 2A, ‘μ’-centered FIG. 2B, ‘−P’-centered FIG. 2C, ‘V’-centered FIG. 2D, ‘T’-centered FIG. 2E, and ‘−S’-centered FIG. 2F. We choose the most important ‘−N’-centered FIG. 2A as the first one to start describing this method since it includes the most common thermodynamic variables (U, H, G, A, T, −S, −P, V, C_{PN}, C_{VN}, O_{PN}, O_{VN}, J_{TN}, J_{SN}, R_{TN}, and R_{SN}) and can depict the most familiar thermodynamic equations.

### III. SPECIFIC NOTATIONS

Mathematical operations involved in most thermodynamic equations are algebraic and calculus, but rarely geometric ones. Thus, some specific graphical notations used in this method should be introduced first.
1. Symbols for selecting variables in the diagrams: Both a large circle ‘◯’ and a small circle ‘∘’ are used for selecting variables located at the vertices of the octahedron or large square. The difference between the large and the small circles is only significant for three variables: −S, −P, and −N. If −S is selected by a large circle it represents −S. whereas if −S is selected by a small circle, it represents S, i.e. +S. A square ‘□’ is used for selecting variables located at the vertices of the cube or small square. A special symbol ‘¤’ is used for selecting variables located at the vertices of the extended polyhedron (rhombicuboctahedron) or octagon.
2. Symbols for some common mathematical operations: A line segment linking two selected variables, such as ‘◯-----◯’ or ‘¤-----¤’, represents a product ‘•’ of the two selected variables. A slash between two symbols, ‘¤/◯’, stands for a ratio of the ‘¤’ selected variable to the large circle ‘◯’ selected variable. Symbols like d, ∂, ∂² and J stand for differential, first order, second order partial derivative operations and Jacobian notation, respectively, as usual. Symbols of addition, ‘+’, subtraction, and equal, ‘=’ are omitted.
3. Arrow's meanings: Arrows stand for either converting directions or the writing order of mathematical expressions or the variable selecting order in depicting an equation. For example, a Legendre transformation between U and H, can be depicted by a graphical pattern, “□→□ ∘---◯ parallel”. This notation can express a Legendre transformation equation: U=H+V·(−P).
4. Specific notations for partial derivatives: A first order partial derivative of a multi-variable function, ƒ=ƒ(x, y, z,), is expressed by

$${( \frac{\partial f}{\partial x} )}_{y , z} .$$

It stands for a first order partial derivative of the multi-variable function, ƒ=ƒ(x, y, z), with respect to one of its variables, x, while holding the other two variables, y & z, constant. Such a mathematical expression of a thermodynamic first order partial derivative,

$${( \frac{\partial f}{\partial x} )}_{y , z} ,$$

can be resolved into two parts: a specific graphical pattern (‘∂◯→∂∘→∘ & ∘’ or ‘∂□→∂∘→∘ & ∘’) and a series of different thermodynamic variables (ƒ, x, y & z). Therefore, for example,

$${( \frac{\partial G}{\partial T} )}_{P , N}$$

can be graphically depicted by overlapping the graphical pattern (∂□→∂∘→∘ & ∘) & co on the diagram to pick the involved variables (G, T, P,& N) up, and combining them together to be ∂(G)→∂(T)→(P) & (N), which stands for

$${( \frac{\partial G}{\partial T} )}_{P , N} .$$

5. Symbols of symmetry: Polyhedrons exhibit symmetry, such as mirror symmetry (σ), three fold and four fold rotation symmetries (C₃ and C₄). These symmetries play an important role in this method.

### IV. General Procedure

Based on the equivalence principle of symmetry (reproducibility and predictability)^{[11]}, if we knew a sample member of any family, we would be able to know all other members of the family through symmetrical operations. A general procedure to do so includes following steps:
Step 1: Use the (0, 0, −1) projection diagram (FIG. 2A), which consists of sixteen thermodynamic variables at the vertices of two squares and one extended octagon.
Step 2: Choose a most familiar member of any family as the sample member of the family to create a graphical pattern for depicting that member of the family on the FIG. 2A. It includes selecting symbols for mathematical expressions and all involved variables, and arranging them in a writing order to be a specific pattern for that member of the family.
Step 3: Overlap this movable specific graphical pattern on the fixed FIG. 2A to depict other members of the family through σ and/or C₄ symmetrical operations one by one.
Step 4: Replace the FIG. 2A by other FIG. 2B FIG. 2F respectively, use the same graphical pattern, repeat the Step 3, further to depict all members of the family. We can use above procedure to verify the symmetry truly existing in thermodynamics.

### V. Graphical Patterns

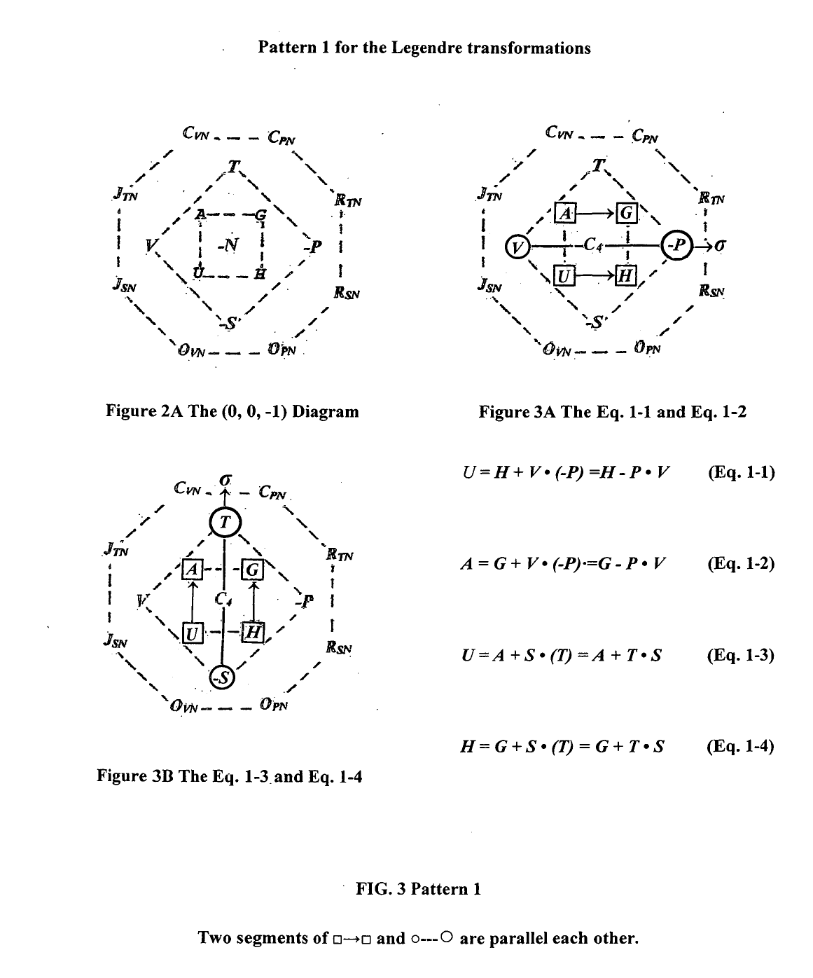

For twelve thermodynamic families, twelve specific graphical patterns have been developed, and shown in FIG. 3 to FIG. 14 with brief descriptions, which are given respectively as follows:
1. Pattern 1 for the Legendre transformations ^{[12]} shown in FIG. 3

A member of the family: U=H−PV

or H=U+PV

Analysis: U=H−PV=H+V·(−P)

or H=U+PV=U+P·(V) (Eq. 1-1)
It can be seen in the FIG. 2A that above two equations are a pair of reversible linear conversions between a pair of the closest thermodynamic potentials (U and II) located at two closest vertices of the small square, that the second term of the equations is a product of two conjugate variables (−P and V) parallel located at the both ends of a diagonal of the large square, and that sign of the product term depends on the sign of its second variable, which is close to the converting potential rather than the converted one.
The involved variables in the equation are:

U H V −P

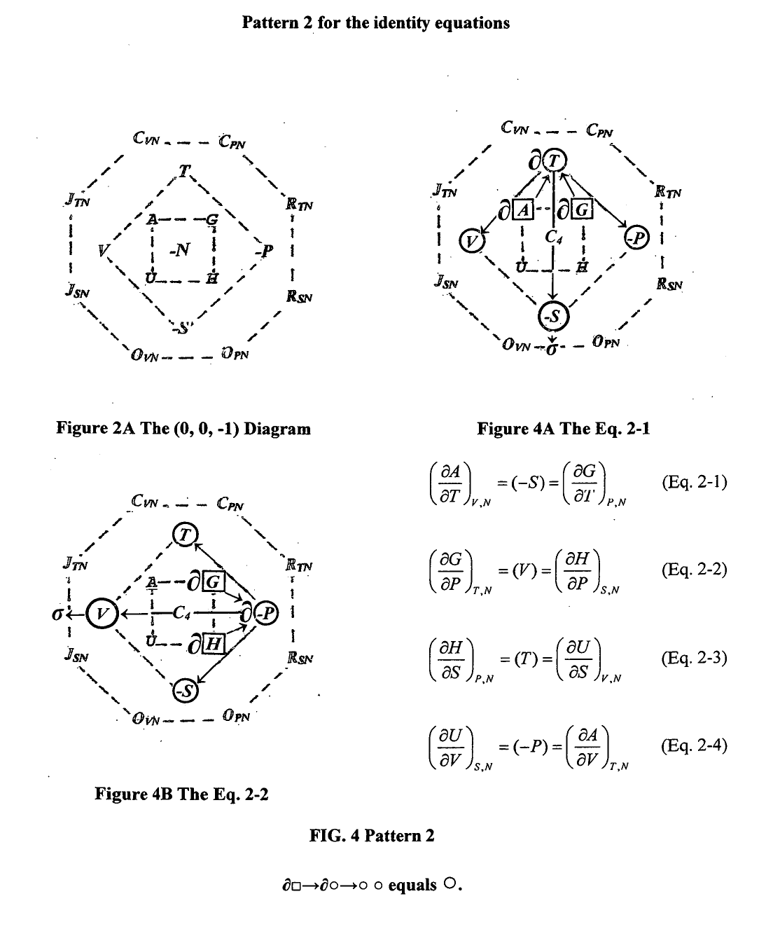

or H U −P V
Symbols for selecting these variables are: □ □ ∘ ◯,
where the first circle must be small, and the second one must be large, since only the last variable's sign should be taken into account.
Thus, a special graphical pattern (Pattern 1) could be created by adding a converting direction symbol between two squares, □ and □, and a line segment symbol between two circles, ∘ and ◯, to become □→□ ∘----◯
i. e. Two segments of ‘□+□’ and ‘∘---◯’ are parallel each other
It can be seen in FIG. 3A that both Eq. 1-1,U=H−P·V, and Eq. 1-2, A=G−P·V, can be depicted by the Pattern 1, and that two graphical patterns display a mirror symmetry (σ) with respect to a diagonal of the large square (V˜−P). Also it can be seen that both Eq. 1-3, U=A+T·S, and Eq. 1-4, H=G+T·S, can be depicted by the same way in FIG. 3B, which can be obtained from the FIG. 3A by a C₄ operation of the mirror symmetrical Pattern 1 (rotating 90°, counterclockwise about the center of the diagram).
Further follow up the Step 3 and Step 4 of the general procedure, all other members of the family can similarly be depicted on the spot one by one. The total members in this family are twenty four, since there are twelve sides in the cube, and two reversible conversions for each side.
2. Pattern 2 for the thermodynamic identity equations shown in FIG. 4
   A member of this family:

$${( \frac{\partial A}{\partial T} )}_{VN} = - S \qquad ( Eq . 2 \text{-} 1 )$$

Analysis: It can be seen in the FIG. 2A that left side of the equation is a partial derivative of the Helmholtz free energy, A, with respect to one of its correlated variables, temperature T, while holding its other two correlated variables, V & N, constant, and that right side of the equation is −S, which is the temperature (T)'s conjugate variable located at the temperature-opposite vertex in the large square.
Thus a special graphical pattern (Pattern 2) could be created for the identity equations as:

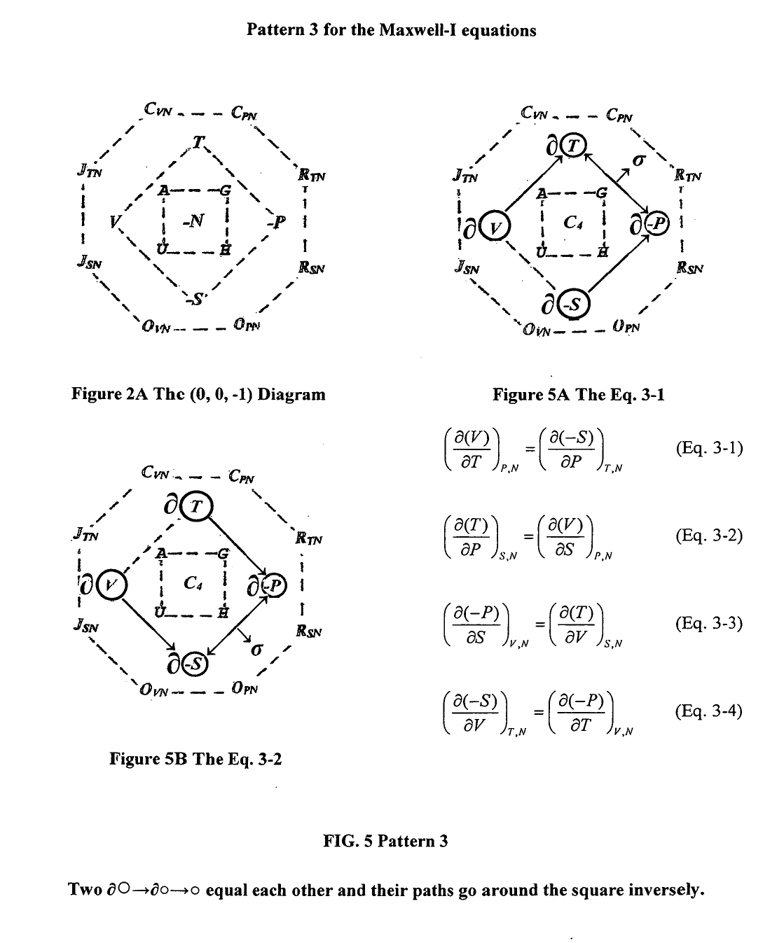

∂□→∂◯→◯◯ equals ◯
where the last circle must be large in order to take the first order derivative variable's sign into account.
Overlap the movable Pattern 2 on the fixed {1, 0, 0} diagrams (FIG. 2A to FIG. 2F) through σ and C₄ symmetrical operations, all equations can be depicted one by one. For example, Eq. 2-1 and Eq. 2-2 can be depicted by FIG. 4A and FIG. 4B, respectively.
The number of total members of this family is twenty four, since there are eight thermodynamic potentials and each one has three correlated natural variables.
3. Pattern 3 for the Maxwell equations shown in FIG. 5.
   A member of this family:

$${( \frac{\partial V}{\partial T} )}_{PN} = - {( \frac{\partial S}{\partial P} )}_{TN} \qquad ( Eq . 3 \text{-} 1 )$$

Analysis: It could be seen in the FIG. 2A and the rewritten Eq. 3-1,

$${( \frac{\partial V}{\partial T} )}_{PN} = {( \frac{\partial ( - S )}{\partial P} )}_{TN} ,$$

that the equation contains two Maxwell-I partial derivatives, where the first three variables are located at the vertices of the large square and the last one at the center of the square, and that two paths for selecting the first three variables go around the square clockwise and counterclockwise, respectively, with mirror symmetry with respect to a diagonal of the small square. Thus, a special graphical pattern (Pattern 3) could be created for the Maxwell equations as:

Two “∂◯→∂◯→◯ & ◯” paths go around the square with ‘σ’ symmetry.
where the first circle must be large in order to take the first variable's sign into account.
Overlap the movable Pattern 3 on the fixed {1, 0, 0} diagrams (FIG. 2A to FIG. 2F) through C₄ symmetrical operations, all twenty four equations can be depicted one by one. For example, Eq. 3-1 and Eq. 3-2 can be depicted by FIG. 5A and FIG. 5B, respectively. However there are only twenty one equations truly with physical meaning since three intensive natural variables (T, P, μ) are impossible to coexist. Therefore following three ones should be excluded from the Maxwell equations:

$${( \frac{\partial ( - S )}{\partial P} )}_{T μ} = {( \frac{\partial ( V )}{\partial T} )}_{P μ} = {∞ \\ ( \frac{\partial ( V )}{\partial μ} )}_{PT} = {( \frac{\partial ( - N )}{\partial P} )}_{μ T} = {∞ \\ ( \frac{\partial ( - N )}{\partial T} )}_{μ P} = {( \frac{\partial ( - S )}{\partial μ} )}_{TP} = ∞$$

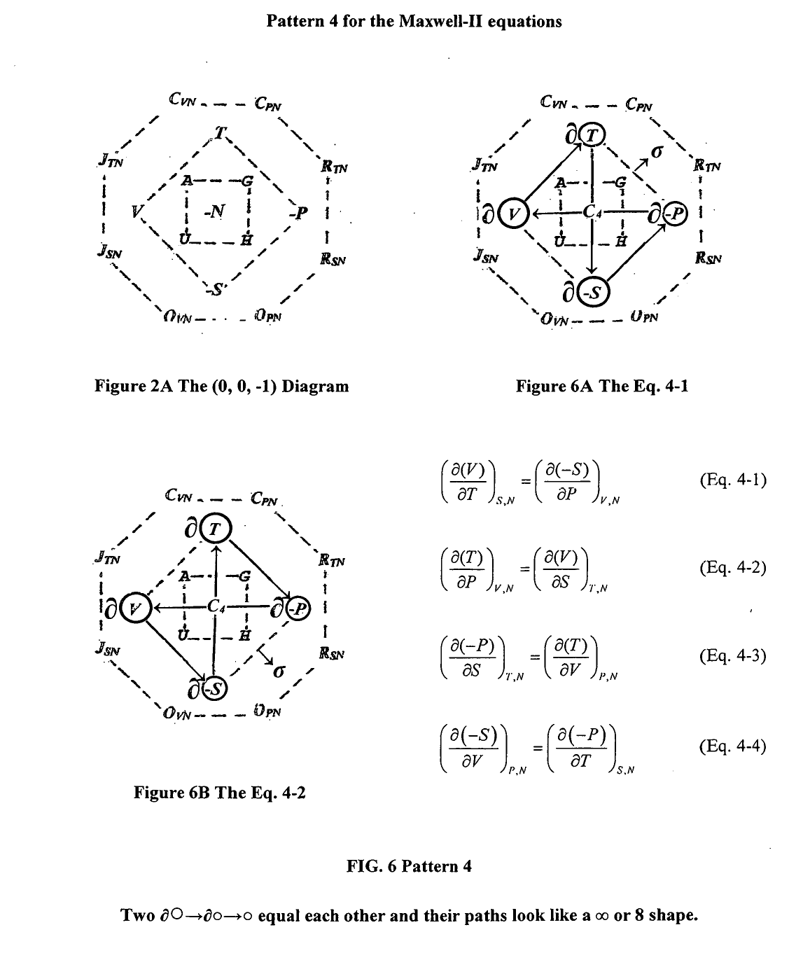

4. Pattern 4 for the Maxwell-II equations shown in FIG. 6
   A member of this family:

$${( \frac{\partial V}{\partial T} )}_{SN} = - {( \frac{\partial S}{\partial P} )}_{VN} \qquad ( Eq . 4 \text{-} 1 )$$

Analysis: This equation really is an inverted Maxwell equation. It could be seen in the FIG. 2A and the rewritten Eq. 4-1,

$${( \frac{\partial ( V )}{\partial T} )}_{SN} = - {( \frac{\partial ( - S )}{\partial P} )}_{VN} ,$$

that the equation contains two Maxwell-II partial derivatives, where the first three variables are also located at the vertices of the large square, and that two paths for selecting first three variables go around the square first, then pass through the center of the square with mirror symmetry with respect to a diagonal of the small square. Thus, a special ‘8 or ∞’ shaped graphical pattern (Pattern 4) could be created for the Maxwell-II equations as:

Two “∂◯→∂∘→∘ & ∘” paths go through the center like a ‘8 or ∞’ shape
where the first circle must also be large in order to take the first variable's sign into account.
Overlap the movable Pattern 4 on the fixed {1, 0, 0} diagrams (FIG. 2A to FIG. 2F) through C₄ symmetrical operations, all twenty four equations can be depicted one by one. For example, Eq. 4-1 and Eq. 4-2 can be depicted by FIG. 6A and FIG. 6B, respectively. Since the same reason, three intensive natural variables (T, P, μ) are not possible to coexist, values of following three Maxwell-II equations equal zero:

$${( \frac{\partial ( - P )}{\partial S} )}_{T μ} = {( \frac{\partial ( T )}{\partial V} )}_{P μ} = 0$$

$${( \frac{\partial ( μ )}{\partial V} )}_{PT} = {( \frac{\partial ( - P )}{\partial N} )}_{μ T} = 0$$

$${( \frac{\partial ( - T )}{\partial N} )}_{μ P} = {( \frac{\partial ( - μ )}{\partial S} )}_{TP} = 0$$

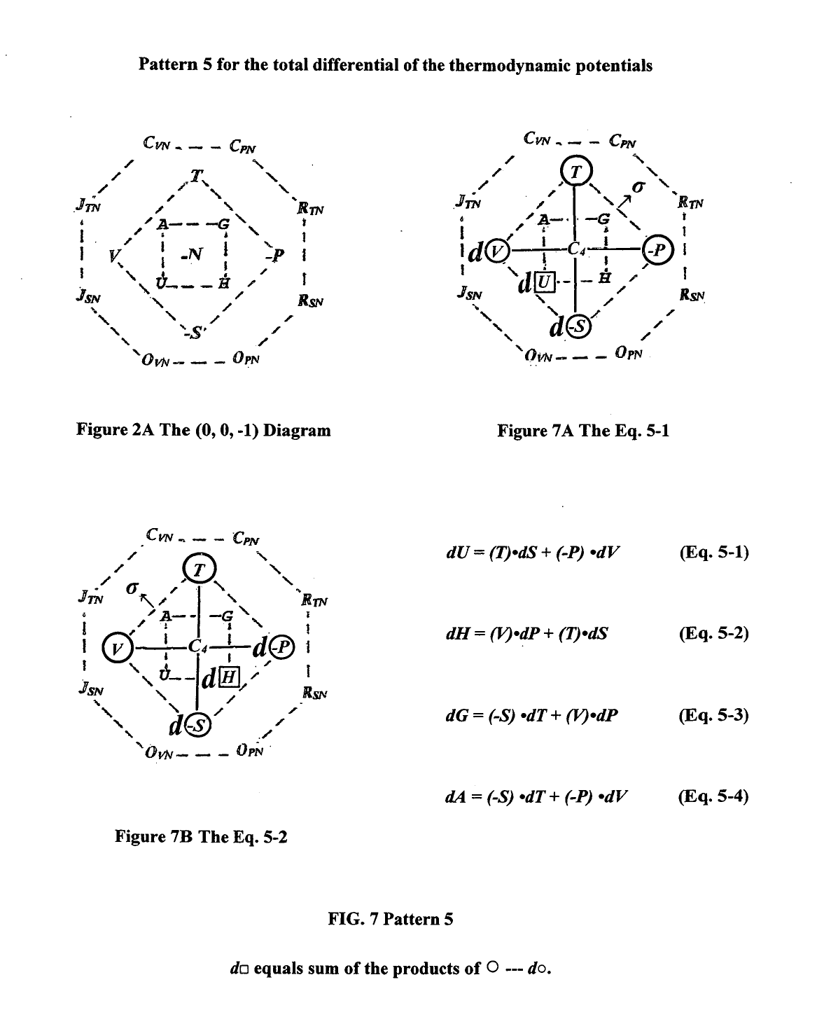

5. Pattern 5 for the total differentials of the thermodynamic potentials shown in FIG. 7

A member of this family: dU=TdS−PdV (Eq. 5-1)
Analysis: It can be seen in the Eq. 5-1 and the FIG. 2A that this equation is a total differential of the internal energy U, U=U(S, V) at N=constant, where the multi-variable function U is located at a vertex of the small square and (−S, V) and (T, −P) are U's first & second neighbor variables located at vertices of the large square, respectively and that the right side of the equation is a sum of two products of the differentials of the U's first neighbor variables (dS and dV) and their corresponding conjugate variables (U's second neighbor variables, T and −P).

That is dU=(T)·dS+(−P)·dV
The involved variables are: U T −S −P V
Variable selecting symbols are: □ ◯ ∘ ◯ ∘
where a square is used for selecting U, the small circles ‘∘’ must be used for selecting U's first neighbors (−S, V), whereas the large circles ‘◯’ must be used for selecting U's second neighbors (T, −P) in order to take their signs into account.
   Finally a specific graphical pattern (Pattern 5) could be created by inserting additional mathematical symbols to become: d□ ◯---d∘ ◯---d∘
   or d□ equals sum of the products of ◯---d∘
   All total differential equations could be depicted by overlapping the movable Pattern 5 on the fixed {1, 0, 0} diagrams through C₄ symmetrical operations one by one. For example, Eq. 5-1 and Eq. 5-2 can be depicted by FIG. 7A and FIG. 7B, respectively.
   There are twenty four (8×3) members in this family. One of them is the well-known Gibbs-Duhem equation:

dΦ=(−S)·dT+(V)·dP=0(N=constant)

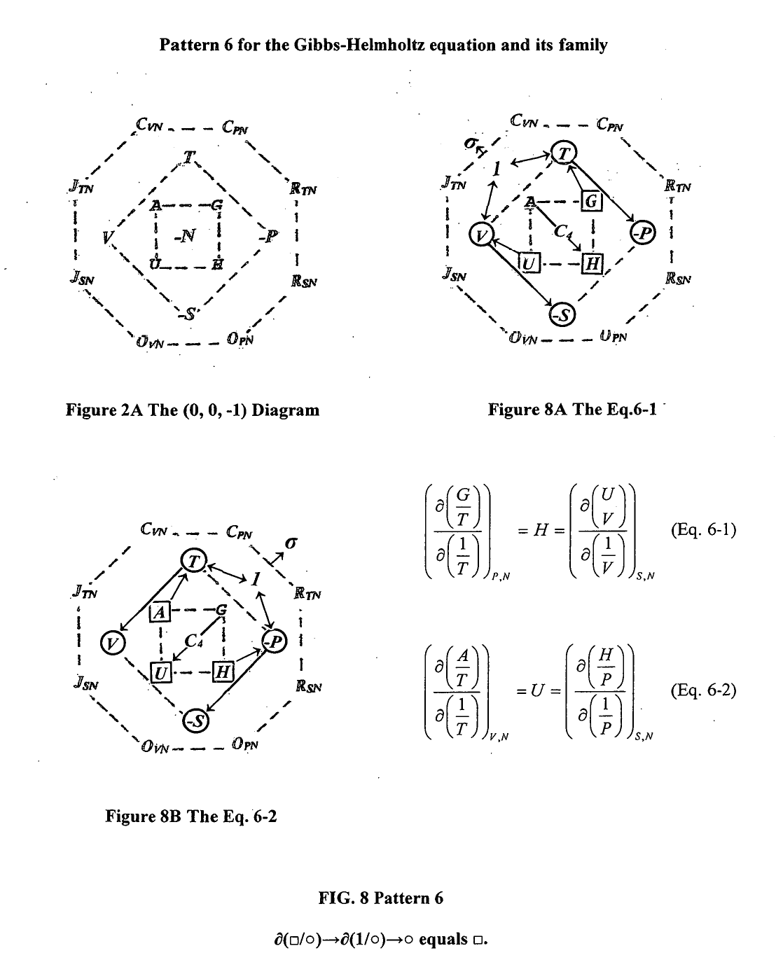

In above five patterns (Pattern 1˜5), it has been found out that symmetry surely exists in thermodynamics and those basic thermodynamic equations were concisely depicted by this graphical method. In following part, some novel equations, novel variables, and relationships among the novel variables would be further developed and/or invented by this symmetrical method.
6. Pattern 6 for the Gibbs-Helmholtz equation and its family shown in FIG. 8
   When we discuss temperature dependence of the Gibbs free energy, the famous Gibbs-Helmholtz equation is satisfied as

$${( \frac{\partial ( G / T )}{\partial T} )}_{PN} = - \frac{H}{{T}^{2}} or {( \frac{\partial ( \frac{G}{T} )}{\partial ( \frac{1}{T} )} )}_{PN} = H \qquad ( Eq . 6 \text{-} 1 )$$

Analysis: It can be seen in the Eq. 6-1 and the FIG. 2A that the left side of the equation,

$${( \frac{\partial ( \frac{G}{T} )}{\partial ( \frac{1}{T} )} )}_{PN} = H ,$$

is a complex first order partial derivative and the right side is simply a thermodynamic potential (enthalpy, H) located at a vertex of the small square. The involved variables in the equation are (G/T), (1/T), P, N, and H The symbols for mathematical expressions and for variable selecting in the equation are ∂(□/∘)→∂(1/∘)→∘ & ∘ and □. Therefore, a special graphical pattern (Pattern 6) for this equation could be created as:

∂(□/∘)→∂(1/∘)→∘ & ∘ equals □
where the necessary number ‘1’ is inserted in the pattern and it is located at an extended location of the small square's diagonal (H˜A). Thus the Eq. 6-1,

$${( \frac{\partial ( \frac{G}{T} )}{\partial ( \frac{1}{T} )} )}_{PN} = H ,$$

can be depicted by the Pattern 6 shown in FIG. 8A.
If we consider the Eq. 6-1,

$${( \frac{\partial ( \frac{G}{T} )}{\partial ( \frac{1}{T} )} )}_{PN} = H ,$$

i. e. the temperature dependence of the Gibbs free energy (the Gibbs-Helmholtz equation), as a sample member of its family, then other members of the family could be predicted by the Pattern 6 through symmetrical operations based on the symmetry principle. For example, a novel member of this family, volume dependence of the internal energy,

$${( \frac{\partial ( \frac{U}{V} )}{\partial ( \frac{1}{V} )} )}_{SN} = H ,$$

could be developed (or predicted) by the movable Pattern 6 operating through a mirror symmetry with respect to the small square's diagonal (H˜A) and graphically depicted by the mirror symmetrical Pattern 6 on the FIG. 8A.
Similarly, another novel member of this family (Eq. 6-2), pressure dependence of the enthalpy,

$${( \frac{\partial ( \frac{H}{P} )}{\partial ( \frac{1}{P} )} )}_{SN} = U ,$$

could also be developed (or predicted) by the movable Pattern 6 operating through a C₄ rotational operation (rotating 90°, clockwise) about the center (−N) of the diagram on the FIG. 8A, and graphically depicted by the Pattern 6 on FIG. 8B.
Above two novel members of this family, the volume dependence of the internal energy and the pressure dependence of the enthalpy, could be proven to be true respectively as follows:

$$\begin{matrix} Proof 1 \text{:} U = H + V \cdot ( - P ) = H - PV & ( Using Pattern 1 ) \\ \frac{U - H}{V} = - P = {( \frac{\partial U}{\partial V} )}_{SN} = \frac{U}{V} - \frac{H}{V} then & ( Using Pattern 2 ) \\ {( \frac{\partial U}{\partial V} )}_{SN} = - \frac{U}{V} = - \frac{H}{V} & Eq . 6 \text{-} {1}^{′} \text{-} 1 \\ {( \frac{\partial ( U / V )}{\partial V} )}_{SN} = \frac{1}{V} {( \frac{\partial U}{\partial V} )}_{SN} + {U ( \frac{\partial ( 1 / V )}{\partial V} )}_{SN} = \frac{1}{V} {( \frac{\partial U}{\partial V} )}_{SN} + U {( \frac{- 1}{{V}^{2}} )}_{SN} = \frac{1}{V} \{ {( \frac{\partial U}{\partial V} )}_{SN} - \frac{U}{V} \} = \frac{1}{V} \{ - \frac{H}{V} \} = - \frac{H}{{V}^{2}} then & ( Using Eq . 6 \text{-} {1}^{′} \text{-} 1 ) \\ - {{V}^{2} ( \frac{\partial ( U / V )}{\partial V} )}_{SN} = H = {( \frac{\partial ( U / V )}{\partial ( 1 / V )} )}_{SN} & ( Eq . 6 \text{-} {1}^{′} is true ) \\ Proof 2 \text{:} H = U + P \cdot ( V ) = U + PV & ( Using Pattern 1 ) \\ \frac{H - U}{P} = V = {( \frac{\partial H}{\partial P} )}_{SN} = \frac{H}{P} - \frac{U}{P} then & ( Using Pattern 2 ) \\ {( \frac{\partial H}{\partial P} )}_{SN} - \frac{H}{P} = - \frac{U}{P} & Eq . 6 \text{-} 2 \text{-} 1 \\ {( \frac{\partial ( H / P )}{\partial P} )}_{SN} = \frac{1}{P} {( \frac{\partial H}{\partial P} )}_{SN} + {H ( \frac{\partial ( 1 / P )}{\partial P} )}_{SN} = \frac{1}{P} {( \frac{\partial H}{\partial P} )}_{SN} + H {( \frac{- 1}{{P}^{2}} )}_{SN} = \frac{1}{P} \{ {( \frac{\partial H}{\partial P} )}_{SN} - \frac{H}{P} \} = \frac{1}{P} \{ - \frac{U}{P} \} = - \frac{U}{{P}^{2}} then & ( Using Eq . 6 \text{-} {2}^{′} \text{-} 1 \\ - {P}^{2} = {( \frac{\partial ( H / P )}{\partial P} )}_{SN} = U = {( \frac{\partial ( H / P )}{\partial ( 1 / P )} )}_{SN} & ( Eq . 6 \text{-} 2 is true )\end{matrix}$$

Using the same way above, remaining forth five members of this family could be one by one developed by overlapping the movable Pattern 6 on the six fixed {1, 0, 0} diagrams (the FIG. 2A to FIG. 2F) through σ and C₄ symmetrical operations graphically and justifying them theoretically. It has been found that six members of this family are not true, for example,

$${( \frac{\partial ( \frac{Φ}{μ} )}{\partial ( \frac{1}{μ} )} )}_{TP} \neq G ,$$

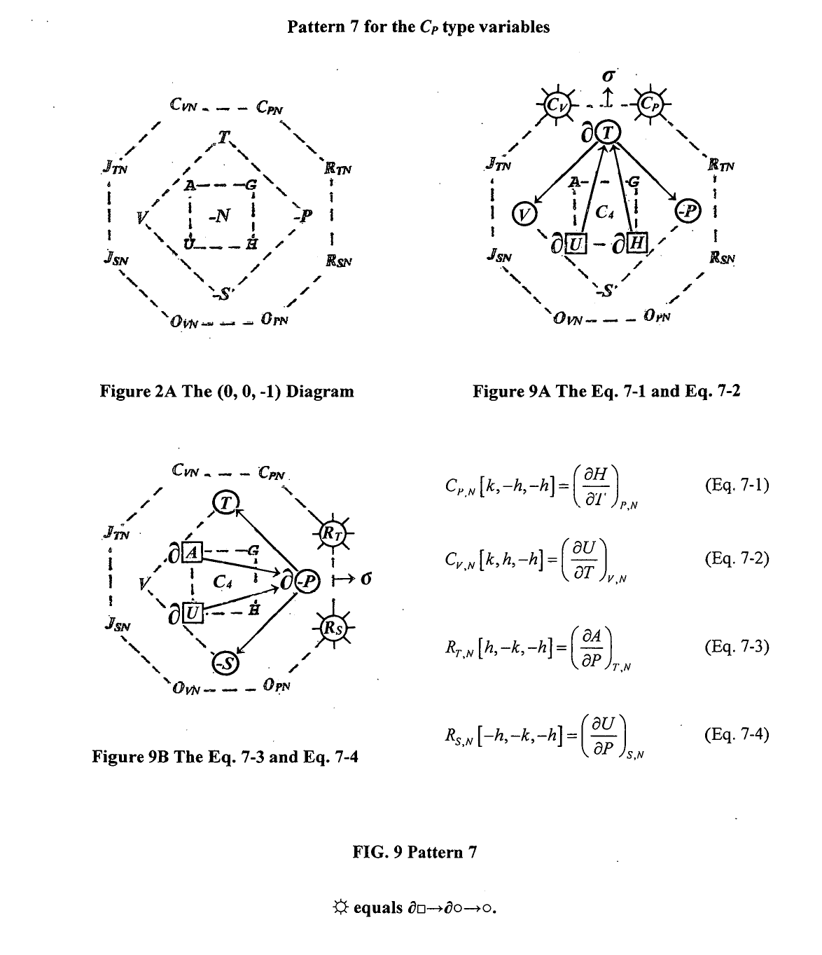

since Φ(T, P, μ)=0.
7. Pattern 7 for the C_{P} type variables shown in FIG. 9
   As all we know that Cp (isobaric thermal capacity) and C_{V} (isochoric thermal capacity) are very important material properties in thermodynamics, they are second order derivatives of the thermodynamic potentials, G=G(T, P, N) and A=A(T, V, N), based on their definitions.

$${C}_{PN} = {( \frac{\partial H}{\partial T} )}_{PN} = {( \frac{\partial ( G + TS )}{\partial T} )}_{PN} = {( \frac{\partial G}{\partial T} )}_{TN} + {T ( \frac{\partial S}{\partial T} )}_{PN} + S = - S + {T ( \frac{\partial S}{\partial T} )}_{PN} + S = {T ( \frac{\partial S}{\partial T} )}_{PN} = - {T ( \frac{{\partial }^{2} G}{\partial {T}^{2}} )}_{PN} and$$

$${C}_{VN} = {( \frac{\partial U}{\partial T} )}_{VN} = {( \frac{\partial ( A + TS )}{\partial T} )}_{VN} = {( \frac{\partial A}{\partial T} )}_{VN} + {T ( \frac{\partial S}{\partial T} )}_{VN} + S = - S + {T ( \frac{\partial S}{\partial T} )}_{VN} + S = {T ( \frac{\partial S}{\partial T} )}_{VN} = - {T ( \frac{{\partial }^{2} A}{\partial {T}^{2}} )}_{VN}$$

Therefore C_{PN} and C_{VN} were properly located at the vertices of the extended octagon, and close to their correlated variables (G, T & P and A, T & V, respectively) in the FIG. 2A based on their physical meaning.
Thus a specific graphical pattern (Pattern 7) could be created for this kind of C_{P} type variables as: ¤ equals ∂□→∂∘→∘∘
It can be seen in FIG. 9A that a pair of the C_{P} type variables (C_{PN} and C_{VN}), i.e., Eq. 7-1 and Eq. 7-2, can be depicted by a pair of the mirror (σ) symmetrical Patterns 7 with respect to the large square's diagonal (−S T).
If we rotate the movable pair of the mirror (σ) symmetrical Patterns 7 on the FIG. 9A through a C₄ operation (rotating 90°, clockwise) about the center (−N) of the diagram to become FIG. 9B, where another new pair of the C_{P} type variables (R_{TN} and R_{SN}), i.e., Eq. 7-3 and Eq. 7-4, would be graphically developed (or invented). If we further rotate the symmetrical Patterns 7 on FIG. 9A through the C₄ operations (180° and 270° clockwise), another four C_{P} type variables (O_{PN}, O_{VN}, J_{TN}, and J_{SN}), i.e., Eq. 7-5 to Eq. 7-8, would be developed (or invented)^{[7]}.

$$\begin{matrix}{O}_{PN} [ - k , - h , - h ] = {( \frac{\partial G}{\partial S} )}_{PN} & ( 7 \text{-} 5 ) \\ {O}_{VN} [ - k , h , - h ] = {( \frac{\partial A}{\partial S} )}_{VN} & ( 7 \text{-} 6 ) \\ {J}_{SN} [ - h , k , - h ] = {( \frac{\partial H}{\partial V} )}_{SN} & ( 7 \text{-} 7 ) \\ {J}_{TN} [ h , k , - h ] = {( \frac{\partial G}{\partial V} )}_{TN} & ( 7 \text{-} 8 )\end{matrix}$$

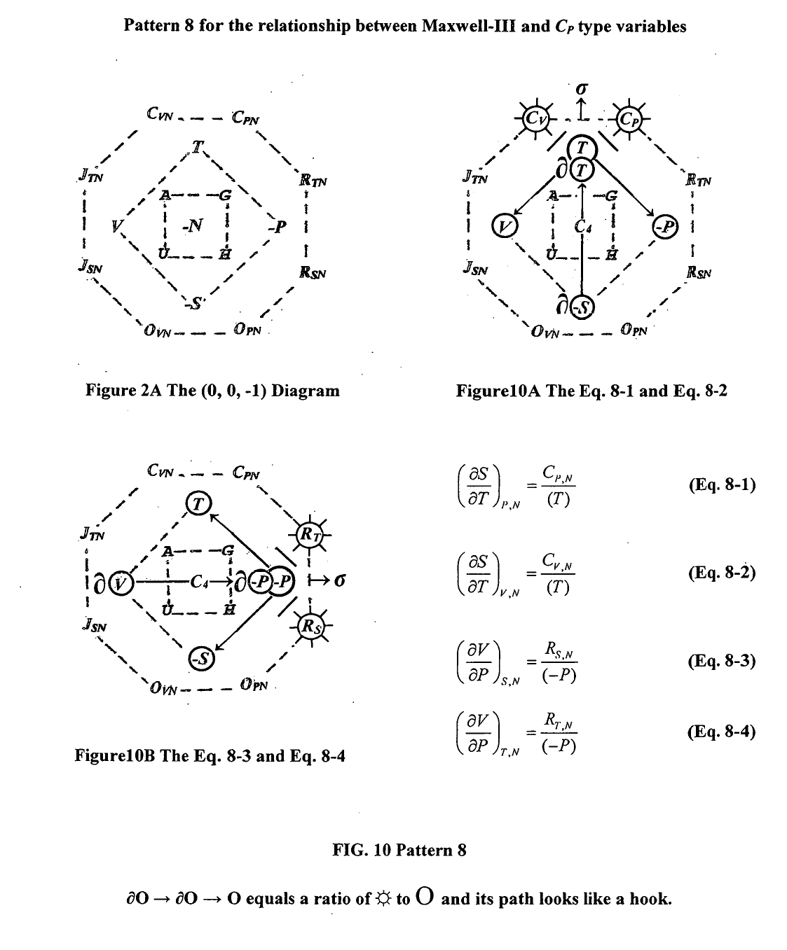

Similarly, other sixteen members of the C_{P} family (C_{Pμ}, C_{Vμ}, O_{Pμ}, O_{Vμ}, J_{Tμ}, J_{Sμ}, R_{Tμ}, R_{Sμ}, Λ_{PT}, Λ_{VT}, Γ_{PT}, Γ_{VT}, Λ_{PS}, Λ_{VS}, Γ_{PS}, & Γ_{VS}) could be developed (or invented) by the same way on the other 2-D {1, 0, 0} diagrams (FIG. 2B to FIG. 2F).
8. Pattern 8 for the relations between Maxwell-III and C_{P} type variables shown in FIG. 10
   It could be found out that the thermodynamic properties (C_{P} & C_{V}) of a system are not only related with the second order partial derivatives of the thermodynamic potentials (G & A), but also related to so-called Maxwell-III partial derivatives, such as

$${C}_{PN} = {T ( \frac{\partial S}{\partial T} )}_{PN} and {C}_{VN} = {T ( \frac{\partial S}{\partial T} )}_{VN} .$$

In other words, the Maxwell-III partial derivatives are related with material's properties or the second order partial derivatives.
A member of this family:

$${( \frac{\partial S}{\partial T} )}_{PN} = \frac{{C}_{PN}}{( T )} \qquad ( Eq . 8 \text{-} 1 )$$

Analysis: It could be seen in the Eq. 8-1 and the FIG. 2A that the left side of the equation is the so-called Maxwell-III partial derivative, where the first three variables are also located at the vertices of the large square, and path for selecting first three variables passes through the center of the square first, then goes around the square like ‘a hook’, and that the right side of the equation is a ratio of a second order derivative variable to its neighbor of the first order partial derivatives.
   Thus, a specific graphical pattern (Pattern 8) could be created for this family as:

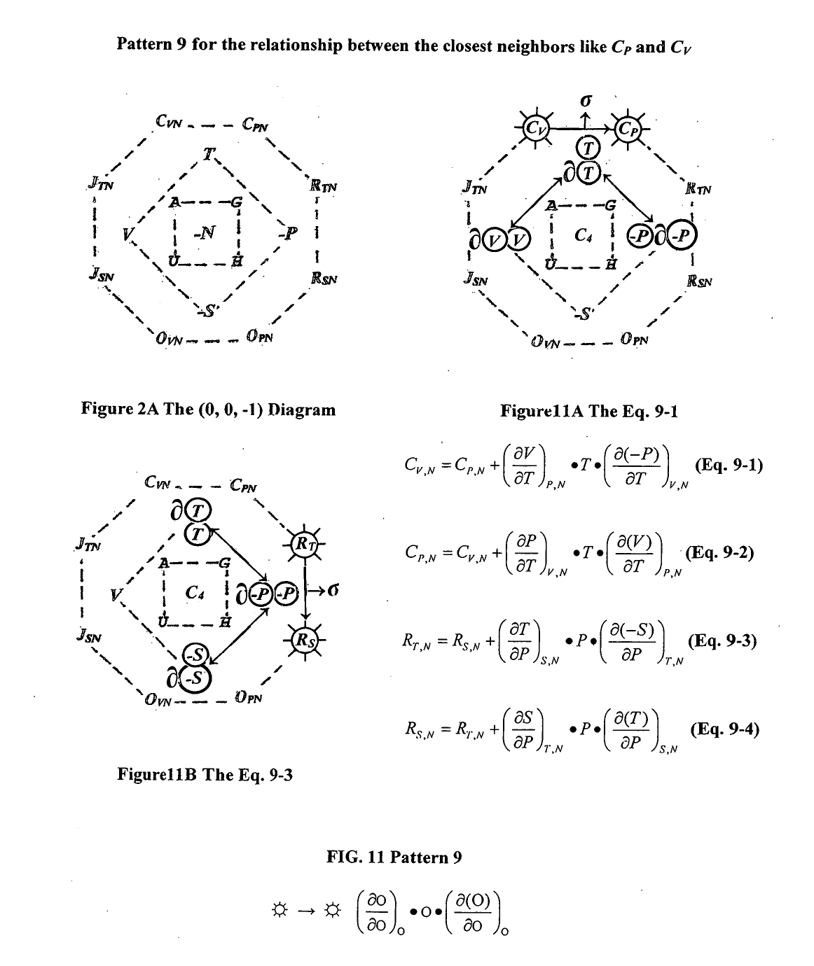

A hook like path of ‘∂∘→∂∘→∘∘’ equals a ratio of ‘¤/◯’
where the last circle must be large in order to take the first order partial derivative variable's sign into account.
It can be seen in FIG. 10 that two pairs of the Eq. 8-1 & Eq. 8-2 and the Eq. 8-3 & Eq. 8-4 can be depicted respectively by two pairs of the mirror (σ) symmetrical Patterns 8 with respect to two large square's diagonals (−S˜T and V˜−P) in FIG. 10A and FIG. 10B, where the latter is produced from the former by a C₄ rotational operation of the mirror (σ) symmetrical Patterns 8 about the center (−N) clockwise.
Total twenty four members of this family could be depicted by overlapping the Pattern 8 on the fixed {1, 0, 0} diagrams (FIG. 2A to FIG. 2F) through σ and C₄ symmetrical operations.
9. Pattern 9 for the relations between the closest neighbors like C_{P} and C_{V} shown in FIG. 11
   We knew an important relation between C_{P} and C_{V}, which is shown below:

$${C}_{P} - {C}_{V} = \frac{{α}^{2} VT}{{κ}_{T}} or {C}_{V} = {C}_{P} - \frac{{α}^{2} VT}{{κ}_{T}}$$

where thermodynamic properties of a system, α and κ_{T}, are defined as:
The isobaric expansion coefficient:

$$α = \frac{1}{V} {( \frac{\partial V}{\partial T} )}_{P}$$

The isothermal compressibility:

$${κ}_{T} = \frac{- 1}{V} {( \frac{\partial V}{\partial P} )}_{T}$$

In order to find out general relations among the twenty four C_{P} type variables for this graphical method, we should derive the general relations and express them in terms of the natural variables (T, S, P, V, μ & N) rather than α and k_{T}.
To start from S=S(V,T) at constant N and take its total differential, then

$$d S = {( \frac{\partial S}{\partial V} )}_{T} d V + {( \frac{\partial S}{\partial V} )}_{T} d T$$

Above equation is divided by ∂T at constant P. This gives

$${( \frac{\partial S}{\partial T} )}_{P} = {( \frac{\partial S}{\partial V} )}_{T} {( \frac{\partial V}{\partial T} )}_{P} + {( \frac{\partial S}{\partial T} )}_{V} then \\ {( \frac{\partial S}{\partial T} )}_{P} - {( \frac{\partial S}{\partial T} )}_{V} = {( \frac{\partial S}{\partial V} )}_{T} {( \frac{\partial V}{\partial T} )}_{P} = {( \frac{\partial P}{\partial T} )}_{V} {( \frac{\partial V}{\partial T} )}_{P} \qquad ( Using Pattern 3 )$$

On the other hand, using above derived result, the C_{P} & C_{V} definitions, and the relations with Maxwell-III partial derivatives,

$${C}_{P} - {C}_{V} = {( \frac{\partial H}{\partial T} )}_{P} - {( \frac{\partial U}{\partial T} )}_{V} = {T ( \frac{\partial S}{\partial T} )}_{P} - {T ( \frac{\partial S}{\partial T} )}_{V} = T ( {( \frac{\partial S}{\partial T} )}_{P} - {( \frac{\partial S}{\partial T} )}_{V} ) = {T ( \frac{\partial P}{\partial T} )}_{V} {( \frac{\partial V}{\partial T} )}_{P} = {( \frac{\partial P}{\partial T} )}_{V} \cdot T \cdot {( \frac{\partial V}{\partial T} )}_{P}$$

We can rewrite this relation of the difference between C_{P} and C_{V} at constant N as:

$$\begin{matrix}{C}_{VN} = {C}_{PN} + {( \frac{\partial V}{\partial T} )}_{PN} \cdot T \cdot {( \frac{\partial ( - P )}{\partial T} )}_{VN} & ( Eq . 9 \text{-} 1 ) \\ {C}_{PN} = {C}_{VN} + {( \frac{\partial P}{\partial T} )}_{VN} \cdot T \cdot {( \frac{\partial ( V )}{\partial T} )}_{PN} & ( Eq . 9 \text{-} 2 )\end{matrix}$$

It could be seen in Eq. 9-1 and Eq. 9-2 that a product term, which consists of three parts (two Maxwell-I partial derivatives and a mid variable, T), is involved in two reversible conversion relations and its sign depends on the sign of numerator variable in the second Maxwell-I partial derivative, and that which variable should be chosen to be the numerator of the second Maxwell-I partial derivative depends on a specific conversion situation. For example, when C_{VN} is converted to C_{PN}, the ‘−P’ variable is chosen to be the numerator of the second Maxwell-I partial derivative,

$${( \frac{\partial ( - P )}{\partial T} )}_{VN} ,$$

in Eq. 9-1, whereas when C_{PN} is converted to C_{VN}, the ‘V’ variable is chosen to be the numerator of the second Maxwell-I partial derivative,

$${( \frac{\partial ( V )}{\partial T} )}_{PN} ,$$

in Eq. 9-2.
In order to check whether such a pair of the relations also symmetrically exist in another pair of C_{P} type variables, such as R_{T} and R_{S}, we start from V=V(T,P) at constant N and take its total differential, then

$$d V = {( \frac{\partial V}{\partial T} )}_{P} d T + {( \frac{\partial V}{\partial T} )}_{T} d P$$

Above equation is divided by ∂P at constant S. This gives

$${( \frac{\partial V}{\partial P} )}_{S} = {( \frac{\partial V}{\partial T} )}_{P} {( \frac{\partial T}{\partial P} )}_{S} + {( \frac{\partial V}{\partial P} )}_{T} then {( \frac{\partial V}{\partial P} )}_{S} - {( \frac{\partial V}{\partial P} )}_{T} = {( \frac{\partial V}{\partial T} )}_{P} {( \frac{\partial T}{\partial P} )}_{S} = - {( \frac{\partial S}{\partial P} )}_{T} {( \frac{\partial T}{\partial P} )}_{S} \qquad ( Using Pattern 3 )$$

On the other hand, using above derived result, the R_{T} and R_{S} definitions, and the relations with Maxwell-III partial derivatives,

$$\begin{matrix}{R}_{T} - {R}_{S} = {( \frac{\partial A}{\partial P} )}_{T} - {( \frac{\partial U}{\partial P} )}_{S} = - {P ( \frac{\partial V}{\partial P} )}_{T} - ( - {P ( \frac{\partial V}{\partial P} )}_{S} ) = - {P ( \frac{\partial V}{\partial P} )}_{T} + {P ( \frac{\partial V}{\partial P} )}_{S} = P ( - {( \frac{\partial V}{\partial P} )}_{T} + {( \frac{\partial V}{\partial P} )}_{S} ) = \\ P ( - {( \frac{\partial S}{\partial P} )}_{T} {( \frac{\partial T}{\partial P} )}_{S} ) = {( \frac{\partial T}{\partial P} )}_{S} \cdot P \cdot {( \frac{\partial ( - S )}{\partial P} )}_{T} then {R}_{TN} = {R}_{SN} + {( \frac{\partial T}{\partial P} )}_{SN} \cdot P \cdot {( \frac{\partial ( - S )}{\partial P} )}_{TN} & ( Eq . 9 \text{-} 3 ) \\ {R}_{SN} = {R}_{TN} + {( \frac{\partial S}{\partial P} )}_{TN} \cdot P \cdot {( \frac{\partial ( T )}{\partial P} )}_{SN} & ( Eq . 9 \text{-} 4 )\end{matrix}$$

It could be seen in Eq. 9-3 and Eq. 9-4 that this kind of two reversible conversion equations has an exact same form as in Eq. 9-1 and Eq. 9-2, where the sign of the product term depends on the sign of the numerator variable in second Maxwell-I partial derivative, that the mid variable (P) and all variables in the partial derivatives are close to both R_{T} and R_{S}, and that which variable should be chosen to be the numerator of the second Maxwell-I partial derivative depends on the specific conversion situation. In these cases, when R_{TN} is converted to R_{SN}, the ‘−S’ variable is chosen to be the numerator of the second Maxwell-I partial derivative,

$${( \frac{\partial ( - S )}{\partial P} )}_{TN} ,$$

in Eq. 9-3, whereas when R_{SN} is converted to R_{TN}, the ‘T’ variable is chosen to be the numerator of the second Maxwell-I partial derivative,

$${( \frac{\partial ( T )}{\partial P} )}_{SN} ,$$

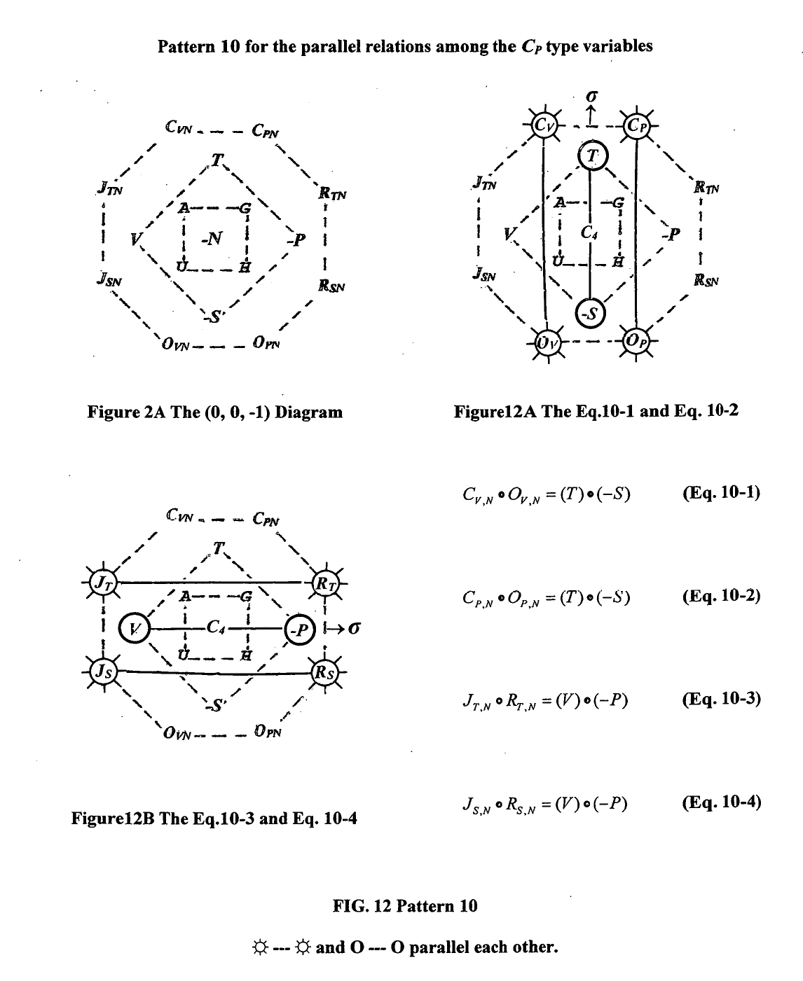

in Eq. 9-4.
There are twenty four pairs of such closest neighbor variables in the extended rhombicuboctahedron, and each pair have two reversible conversion relations. We could use the similar procedure above to prove total forty eight members of this family satisfying a general form like Eq. 9-1, and take Eq. 9-1 as the sample member of this family, follow the general procedure of this method to create a quite complicated graphical pattern (Pattern 9) for this family as:

$$\to {( \frac{\partial O}{\partial O} )}_{O , O} \cdot O \cdot {( \frac{\partial ( O )}{\partial O} )}_{O , O}$$

where the variable selecting paths of two Maxwell-I partial derivatives go around the square reversely each other with a mirror symmetry with respect to a diagonal of the large square, and a large circle must be used for the numerator variable of the second Maxwell-I partial derivative in order to take its sign into account.
Total forty eight members of this family could be depicted by overlapping the Pattern 9 on the fixed {1, 0, 0} diagrams (FIG. 2A to FIG. 2F) through σ and C₄ symmetrical operations. For example, Eq. 9-1 and Eq. 9-3 can be depicted by FIG. 11A and FIG. 11B.
10. Pattern 10 for the parallel relations among the C_{P} type variables shown in FIG. 12
   It was found out that following relations are true:

C_{VN}·O_{VN}=T·(−S)=−TS (Eq. 10-1)

C_{PN}·O_{PN}=T·(−S)=−TS (Eq. 10-2)

J_{TN}·R_{TN}=V·(−P)=−PV (Eq. 10-3)

J_{SN}·R_{SN}=V·(−P)=−PV (Eq. 10-4)
For an example, the Eq. 10-1 could be proven easily as below:

$${C}_{VN} \cdot {O}_{VN} = {T ( \frac{\partial S}{\partial T} )}_{VN} \cdot ( - S ) {( \frac{\partial T}{\partial S} )}_{VN} = T \cdot ( - S )$$

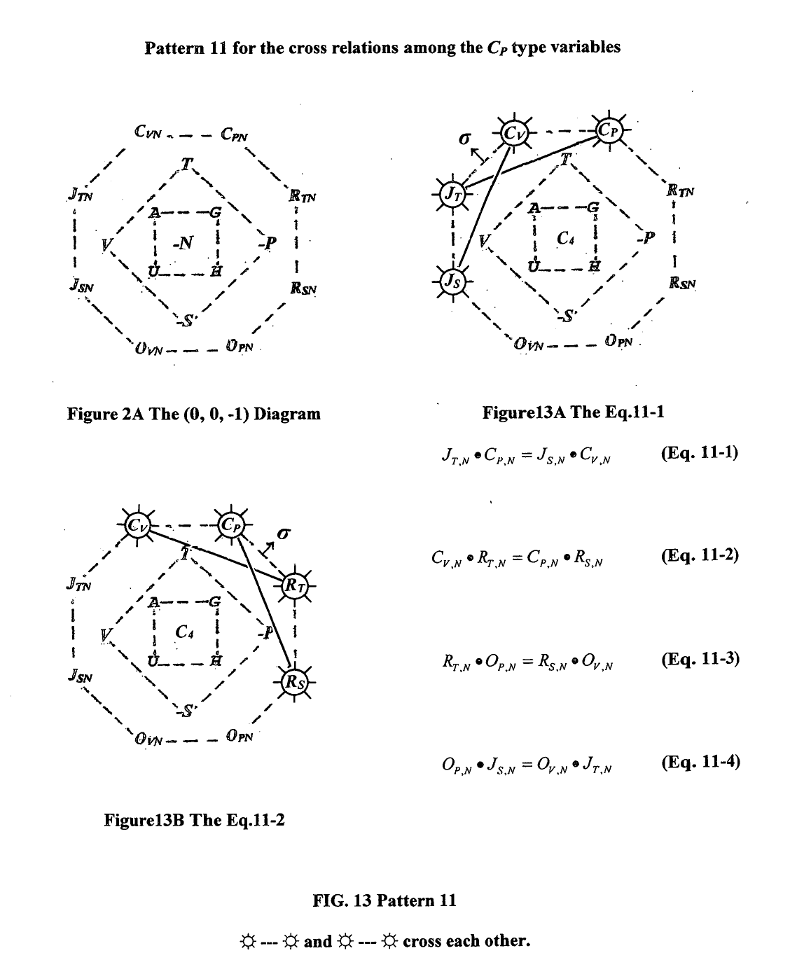

Thus a concise graphical pattern (Pattern 10) could be created in FIG. 2A for this family as: ¤---¤ and ◯---◯ parallel each other
where two circles must be large in order to take selected variable's sign into account.
Total twenty four members of this family could be depicted by overlapping the Pattern 10 on the fixed {1, 0, 0} diagrams (FIG. 2A to FIG. 2F) through σ and C₄ symmetrical operations. For example, two pairs of the Eq. 10-1 to Eq. 10-4 can be depicted on FIG. 12A and FIG. 12B, respectively.
Compared with the conjugate pair relationship among the six first order partial derivative variables (T˜−S, −P˜V, and μ˜−N), such parallel product relations may be similarly considered as conjugate pair relationship among these second order ones. It means that variables located at two ends of the parallel segments in the octagon are conjugated each other, i.e. C_{P}˜O_{P}, C_{V}˜O_{V}, J_{T}˜R_{T}, and J_{S}˜R_{S}.
11. Pattern 11 for the cross relations among the C_{P} type variables shown in FIG. 13.
   It was also found out that following relations are true:

J_{TN}·C_{PN}=J_{SN}·C_{VN} (Eq. 11-1)

C_{VN}·R_{TN}=C_{PN}·R_{SN} (Eq. 11-2)

R_{TN}·O_{PN}=R_{SN}·O_{VN} (Eq. 11-3)

O_{PN}·J_{SN}=O_{VN}·J_{TN} (Eq. 11-4)
For an example, the Eq. 11-1 could be proven by using the relations shown in Pattern 8 (Maxwell-III), Pattern 4 (Maxwell-II), and Pattern 3 (Maxwell-I) as follows:

$${J}_{TN} \cdot {C}_{PN} = {C}_{PN} \cdot {J}_{TN} = {T ( \frac{\partial S}{\partial T} )}_{PN} \cdot {V ( \frac{\partial P}{\partial V} )}_{TN} = {T ( \frac{\partial S}{\partial V} )}_{PN} {( \frac{\partial V}{\partial T} )}_{PN} \cdot {V ( \frac{\partial P}{\partial S} )}_{TN} {( \frac{\partial S}{\partial V} )}_{TN} = T \cdot {V ( \frac{\partial P}{\partial T} )}_{SN} {( \frac{\partial ( - S )}{\partial P} )}_{TN} {( \frac{\partial P}{\partial S} )}_{TN} {( \frac{\partial P}{\partial T} )}_{VN} = T \cdot {V ( \frac{\partial P}{\partial T} )}_{SN} ( - 1 ) {( \frac{\partial P}{\partial T} )}_{VN} = T \cdot {V ( \frac{\partial P}{\partial T} )}_{SN} {( \frac{\partial ( - P )}{\partial S} )}_{VN} {( \frac{\partial S}{\partial P} )}_{VN} {( \frac{\partial P}{\partial T} )}_{VN} = \\ {V ( \frac{\partial P}{\partial T} )}_{SN} {( \frac{\partial T}{\partial V} )}_{SN} \cdot {T ( \frac{\partial S}{\partial P} )}_{VN} {( \frac{\partial P}{\partial T} )}_{VN} = {V ( \frac{\partial P}{\partial V} )}_{SN} \cdot {T ( \frac{\partial S}{\partial T} )}_{VN} = {J}_{SN} \cdot {C}_{VN}$$

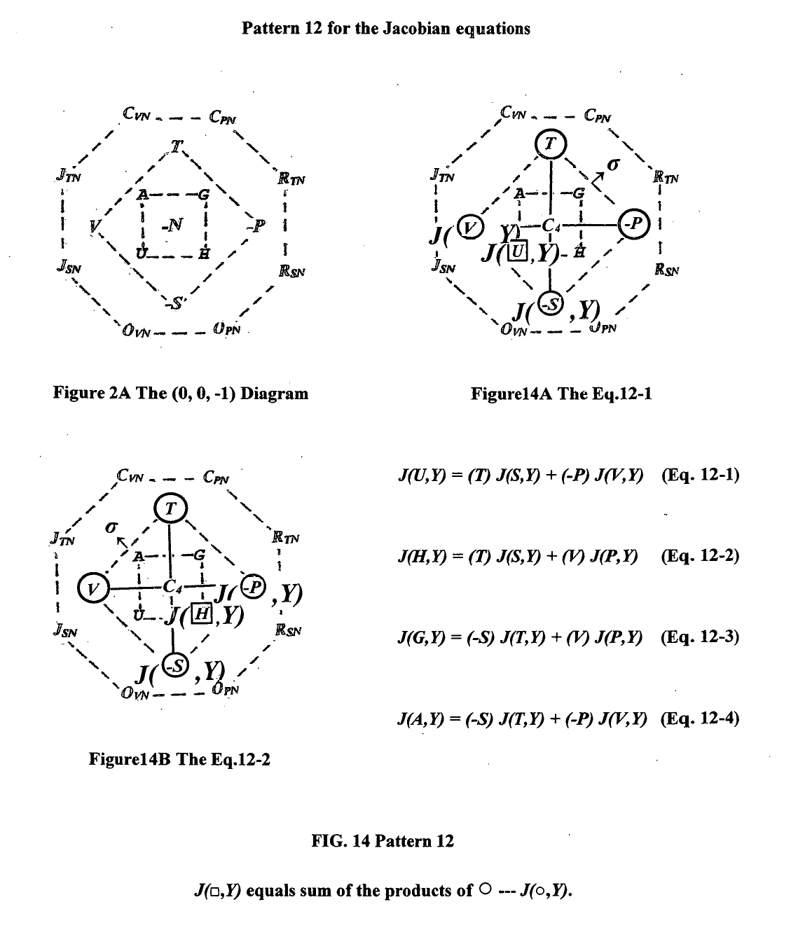

Thus another concise graphical pattern (Pattern 11) could be created in FIG. 2A for this family as: ¤---¤ and ¤---¤ cross each other.
All members of this family can be depicted by overlapping Pattern 11 on the fixed {1, 0, 0} diagrams (FIG. 2A to FIG. 2F) through σ and C₄ symmetrical operations. For example, Eq. 11-1 and Eq. 11-2 can be depicted respectively on FIG. 13A and FIG. 13B. Total members of this family are twenty four, since there are six {1, 0, 0} projection diagrams and four such relations in each {1, 0, 0} diagram,
It could be found in above descriptions (Pattern 1 to Pattern 11) that an integration of the entire structure into a coherent and complete exposition of thermodynamics has been undertaken by this symmetry graphical method.
12. Pattern 12 for the Jacobian equations shown in FIG. 14
   The Jacobian method is powerful and entirely foolproof ^{[13,14]}. If we could combine it with this method, it would be more powerful and useful for any learners to facilitate the subject.
   One of the Jacobian equations at N=constant could be derived from dividing the Eq. 5-1, dU=TdS−PdV=(T)·dS+(−P)·dV (the fundamental thermodynamic equation), by dx at constant y, where x and y are any suitable variables,

$${( \frac{\partial U}{\partial X} )}_{Y} = ( T ) \cdot {( \frac{\partial S}{\partial X} )}_{Y} + ( - P ) \cdot {( \frac{\partial V}{\partial X} )}_{Y}$$

using Jacobian notation, J(,):

$$\frac{J ( U , Y )}{J ( X , Y )} = \frac{\partial ( U , Y )}{\partial ( X , Y )} = - \frac{\partial ( Y , U )}{\partial ( X , Y )} = \frac{\partial ( Y , U )}{\partial ( Y , X )} = {( \frac{\partial U}{\partial X} )}_{Y} thus$$

$$\frac{J ( U , Y )}{J ( X , Y )} = ( T ) \cdot \frac{J ( S , Y )}{J ( X , Y )} = + ( - P ) \cdot \frac{J ( V , Y )}{J ( X , Y )}$$

multiplying by J(X,Y), finally obtaining

J(U,Y)=(T)·J(S,Y)+(−P)·J(V,Y) (Eq. 12-1)
Thus a specific graphical pattern (Pattern 12) could be created in FIG. 2A for this family as

J(□,Y)◯---J(∘,Y)◯---J(∘,Y)

or J(□,Y) equals sum of the products of ◯---J(∘,Y)
This Pattern 12 is similar to Pattern 5:

d□◯---d∘◯---d∘◯---d∘

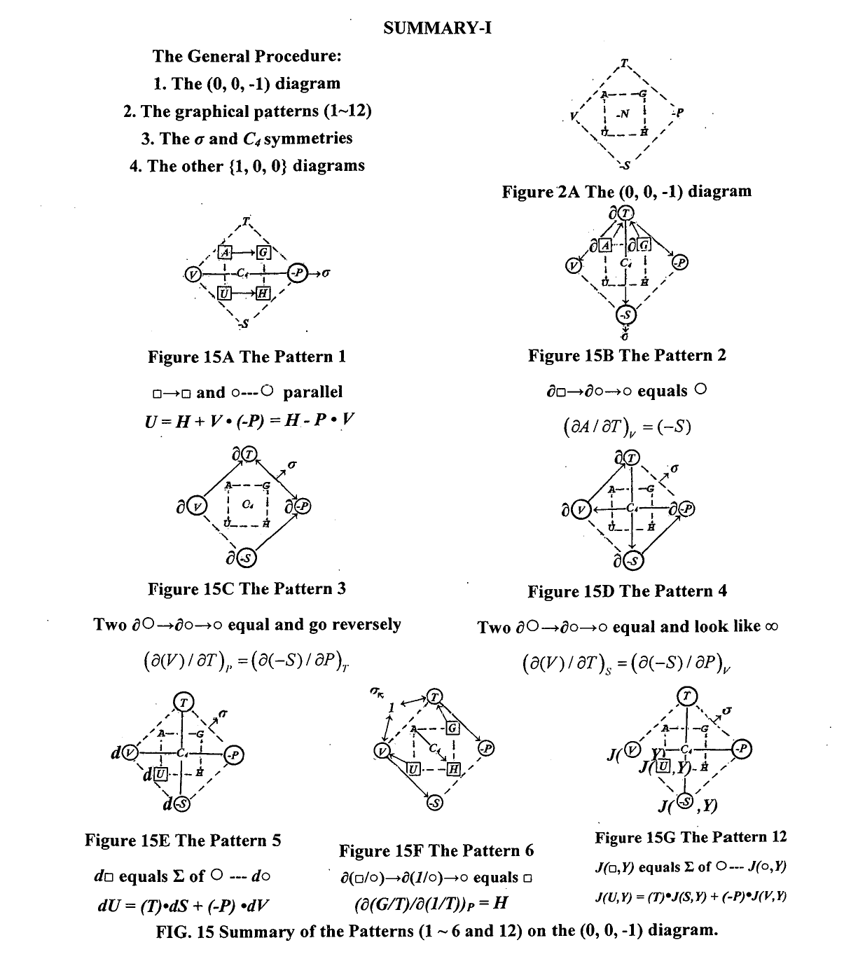

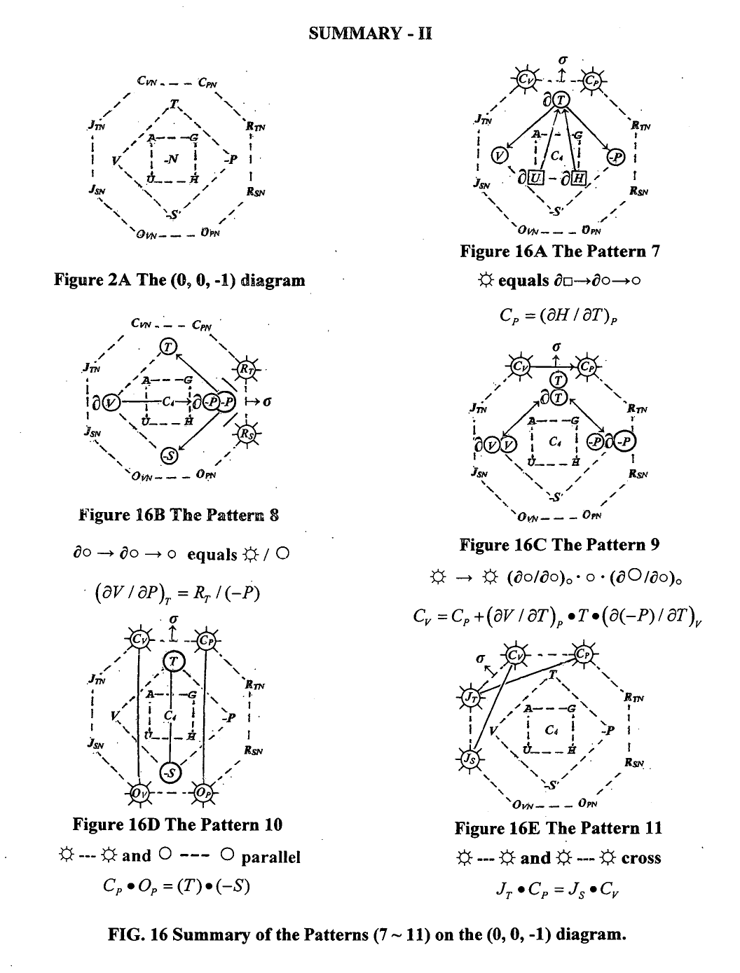

or d□ equals sum of the products of ◯---d∘
Difference between them is a graphical symbol replacement. That is d□ and d∘ in the Pattern 5 being replaced by J(□,Y) and J(∘,Y) in the Pattern 12.
All Jacobian equations could be depicted by overlapping the movable Pattern 12 on the fixed {1, 0, 0} diagrams (the FIG. 2A to FIG. 2F) through C₄ symmetrical operations one by one. For example, Eq. 12-1 and Eq. 12-2 can be depicted on FIG. 14A and FIG. 14-B, respectively.
A brief summary of this symmetry graphical method (Pattern 1 to Pattern 12) is shown in FIG. 15 (FIG. 15A to FIG. 15G) and FIG. 16 (FIG. 16A to FIG. 16E) for user's convenience.
Totally more than three hundred thermodynamic equations of the above twelve families are given in Supporting Material-II: ‘Equations’.

### VI. Express C_{P} Type Variables in Terms of Available Quantities

If we want to know what total differential of a thermodynamic property is, we need to know what its partial derivatives are. Often there is no convenient experimental method to evaluate the partial derivatives needed for the numerical solution of a problem. In this case, we must calculate the partial derivatives and relate them to other quantities that are readily available. The partial derivatives can usually be expressed in terms of the six natural variables and several other available quantities, such as C_{P}, α (the isobaric thermal expansion coefficient), κ_{T}(the isothermal compressibility) and ω (the molar grand canonical potential of the system), where

$$ω = {( \frac{\partial Ω}{\partial N} )}_{VT} , α = \frac{1}{V} {( \frac{\partial V}{\partial T} )}_{P} , and {κ}_{T} = \frac{- 1}{V} {( \frac{\partial V}{\partial P} )}_{T} ,$$

respectively.

Symbols, definitions and values of the 24 C_{P}-type variables are given as follows:

$$\begin{matrix}1. {C}_{PN} = {( \frac{\partial H}{\partial T} )}_{PN} = {T ( \frac{\partial S}{\partial T} )}_{PN} = - {T ( \frac{{\partial }^{2} G}{\partial {T}^{2}} )}_{PN} = {C}_{PN} & ( Eq . VI \text{-} 1 ) \\ 2. {C}_{VN} = {( \frac{\partial U}{\partial T} )}_{VN} = {T ( \frac{\partial S}{\partial T} )}_{VN} = - {T ( \frac{{\partial }^{2} A}{\partial {T}^{2}} )}_{VN} = {C}_{PN} + {( \frac{\partial V}{\partial T} )}_{P , N} \cdot T \cdot {( \frac{\partial ( - P )}{\partial T} )}_{V , N} = {C}_{PN} - \frac{{α}^{2} VT}{{κ}_{T}} & ( Eq . VI \text{-} 2 ) \\ 3. {J}_{TN} = {( \frac{\partial G}{\partial V} )}_{TN} = {V ( \frac{\partial P}{\partial V} )}_{TN} = - {V ( \frac{{\partial }^{2} A}{\partial {V}^{2}} )}_{TN} = \frac{- 1}{{κ}_{T}} & ( Eq . VI \text{-} 3 ) \\ 4. {J}_{SN} = {( \frac{\partial H}{\partial V} )}_{SN} = {V ( \frac{\partial P}{\partial V} )}_{SN} = - {V ( \frac{{\partial }^{2} U}{\partial {V}^{2}} )}_{SN} = \frac{{J}_{TN} \cdot {C}_{PN}}{{C}_{VN}} = \frac{- {C}_{PN}}{{κ}_{T} {C}_{VN}} = \frac{{C}_{PN}}{{α}^{2} VT - {κ}_{T} {C}_{PN}} & ( Eq . VI \text{-} 4 ) \\ 5. {O}_{PN} = {( \frac{\partial G}{\partial S} )}_{PN} = - {S ( \frac{\partial T}{\partial S} )}_{PN} = - {S ( \frac{{\partial }^{2} H}{\partial {S}^{2}} )}_{PN} = \frac{T \cdot ( - S )}{{C}_{PN}} = \frac{- TS}{{C}_{PN}} & ( Eq . VI \text{-} 5 ) \\ 6. {O}_{VN} = {( \frac{\partial A}{\partial S} )}_{VN} = - {S ( \frac{\partial T}{\partial S} )}_{VN} = - {S ( \frac{{\partial }^{2} U}{\partial {S}^{2}} )}_{VN} = \frac{T \cdot ( - S )}{{C}_{VN}} = \frac{{κ}_{T} ST}{{α}^{2} VT - {κ}_{T} {C}_{PN}} & ( Eq . VI \text{-} 6 ) \\ 7. {R}_{TN} = {( \frac{\partial A}{\partial P} )}_{TN} = - {P ( \frac{\partial V}{\partial P} )}_{TN} = - {P ( \frac{{\partial }^{2} G}{\partial {P}^{2}} )}_{TN} = \frac{V \cdot ( - P )}{{J}_{TN}} = {κ}_{T} PV & ( Eq . VI \text{-} 7 ) \\ 8. {R}_{SN} = {( \frac{\partial U}{\partial P} )}_{SN} -- {P ( \frac{\partial V}{\partial P} )}_{SN} = - {P ( \frac{{\partial }^{2} H}{\partial {P}^{2}} )}_{SN} = \frac{V \cdot ( - P )}{{J}_{SN}} = {κ}_{T} PV - \frac{{α}^{2} {V}^{2} PT}{{C}_{PN}} & ( Eq . VI \text{-} 8 ) \\ 9. {O}_{{P}_{μ}} = {( \frac{\partial Φ}{\partial S} )}_{{P}_{μ}} = - {S ( \frac{\partial T}{\partial S} )}_{{P}_{μ}} = - {S ( \frac{{\partial }^{2} χ}{\partial {S}^{2}} )}_{{P}_{μ}} = 0 & ( Eq . VI \text{-} 9 ) \\ 10. {J}_{{T}_{μ}} = {( \frac{\partial Φ}{\partial V} )}_{{T}_{μ}} = {V ( \frac{\partial P}{\partial V} )}_{{T}_{μ}} = - {V ( \frac{{\partial }^{2} Ω}{\partial {V}^{2}} )}_{{T}_{μ}} = 0 & ( Eq . VI \text{-} 10 ) \\ 11. {Γ}_{PT} = {( \frac{\partial Φ}{\partial N} )}_{PT} = {N ( \frac{\partial μ}{\partial N} )}_{PT} = - {N ( \frac{{\partial }^{2} G}{\partial {N}^{2}} )}_{PT} = 0 & ( Eq . VI \text{-} 11 ) \\ 12. {C}_{{P}_{μ}} = {( \frac{\partial χ}{\partial T} )}_{{P}_{μ}} = {T ( \frac{\partial S}{\partial T} )}_{{P}_{μ}} = - {T ( \frac{{\partial }^{2} Φ}{\partial {T}^{2}} )}_{{P}_{μ}} = ∞ & ( Eq . VI \text{-} 12 ) \\ 13. {R}_{{T}_{μ}} = {( \frac{\partial Ω}{\partial P} )}_{{T}_{μ}} = - {P ( \frac{\partial V}{\partial P} )}_{{T}_{μ}} = - {P ( \frac{{\partial }^{2} Φ}{\partial {P}^{2}} )}_{{T}_{μ}} = ∞ & ( Eq . VI \text{-} 13 ) \\ 14. {Λ}_{PT} = {( \frac{\partial G}{\partial μ} )}_{PT} = {μ ( \frac{\partial N}{\partial μ} )}_{PT} = - {μ ( \frac{{\partial }^{2} Φ}{\partial {μ}^{2}} )}_{PT} = ∞ & ( Eq . VI \text{-} 14 ) \\ 15. {C}_{{V}_{μ}} = {( \frac{\partial Ψ}{\partial T} )}_{{V}_{μ}} = {T ( \frac{\partial S}{\partial T} )}_{{V}_{μ}} = - {T ( \frac{{\partial }^{2} Ω}{\partial {T}^{2}} )}_{{V}_{μ}} = {C}_{VN} + {( \frac{\partial μ}{\partial T} )}_{NV} \cdot T \cdot {( \frac{\partial ( - N )}{\partial T} )}_{μ V} = {C}_{PN} - \frac{{α}^{2} {V}^{2} PT}{{κ}_{T}} + {( \frac{\partial μ}{\partial T} )}_{NV} \cdot T \cdot {( \frac{\partial ( - N )}{\partial T} )}_{μ V} & ( Eq . VI \text{-} 15 ) \\ 16. {{J}_{{S}_{μ} =} ( \frac{\partial χ}{\partial V} )}_{{S}_{μ}} = {V ( \frac{\partial P}{\partial V} )}_{{S}_{μ}} = - {V ( \frac{{\partial }^{2} Ψ}{\partial {V}^{2}} )}_{{S}_{μ}} = {J}_{SN} + {( \frac{\partial μ}{\partial V} )}_{NS} \cdot V \cdot {( \frac{\partial ( - N )}{\partial V} )}_{μ S} = \frac{{C}_{PN}}{{α}^{2} VT + {κ}_{T} {C}_{PN}} + {( \frac{\partial μ}{\partial V} )}_{NS} \cdot V \cdot {( \frac{\partial ( - N )}{\partial V} )}_{μ S} & ( Eq . VI \text{-} 16 ) \\ 17. {{O}_{{V}_{μ} =} ( \frac{\partial Ω}{\partial S} )}_{{V}_{μ}} = - {S ( \frac{\partial T}{\partial S} )}_{{V}_{μ}} = - {S ( \frac{{\partial }^{2} Ψ}{\partial {S}^{2}} )}_{{V}_{μ}} = {O}_{VN} + {( \frac{\partial μ}{\partial S} )}_{NV} \cdot S \cdot {( \frac{\partial ( - N )}{\partial S} )}_{μ V} = \frac{{κ}_{T} ST}{{α}^{2} VT + {κ}_{T} {C}_{PN}} + {( \frac{\partial μ}{\partial S} )}_{NV} \cdot S \cdot {( \frac{\partial ( - N )}{\partial S} )}_{μ V} & ( Eq . VI \text{-} 17 ) \\ 18. {R}_{{S}_{μ}} = {( \frac{\partial Ψ}{\partial P} )}_{{S}_{μ}} = - {P ( \frac{\partial S}{\partial P} )}_{{S}_{μ}} = - {P ( \frac{{\partial }^{2} χ}{\partial {P}^{2}} )}_{{S}_{μ}} = {R}_{SN} + {( \frac{\partial μ}{\partial P} )}_{NS} \cdot P \cdot {( \frac{\partial ( - N )}{\partial P} )}_{μ S} = {κ}_{T} PV - \frac{{α}^{2} {V}^{2} PT}{{C}_{PN}} + {( \frac{\partial μ}{\partial P} )}_{NS} \cdot P \cdot {( \frac{\partial ( - N )}{\partial P} )}_{μ S} & ( Eq . VI \text{-} 18 ) \\ 19. {Γ}_{VT} = {( \frac{\partial Ω}{\partial N} )}_{VT} = {N ( \frac{\partial μ}{\partial N} )}_{VT} = - {N ( \frac{{\partial }^{2} A}{\partial {N}^{2}} )}_{VT} = ω & ( Eq . VI \text{-} 19 ) \\ 20. {Λ}_{VT} = {( \frac{\partial A}{\partial μ} )}_{VT} = {μ ( \frac{\partial N}{\partial μ} )}_{VT} = - {μ ( \frac{{\partial }^{2} Ω}{\partial {μ}^{2}} )}_{VT} = \frac{μ \cdot ( - N )}{{Γ}_{VT}} = \frac{- μ N}{ω} & ( Eq . VI \text{-} 20 ) \\ 21. {Γ}_{VS} = {( \frac{\partial Ψ}{\partial N} )}_{VS} = {N ( \frac{\partial μ}{\partial N} )}_{VS} = - {N ( \frac{{\partial }^{2} U}{\partial {N}^{2}} )}_{VS} = {Γ}_{VT} + {( \frac{\partial S}{\partial N} )}_{TV} \cdot N \cdot {( \frac{\partial T}{\partial N} )}_{SV} = ω + {( \frac{\partial S}{\partial N} )}_{TV} \cdot N \cdot {( \frac{\partial T}{\partial N} )}_{SV} & ( Eq . VI \text{-} 21 ) \\ 22. {Γ}_{PS} = {( \frac{\partial χ}{\partial N} )}_{PS} = {N ( \frac{\partial μ}{\partial N} )}_{PS} = - {N ( \frac{{\partial }^{2} H}{\partial {N}^{2}} )}_{PS} = {Γ}_{VS} + {( \frac{\partial P}{\partial N} )}_{VS} \cdot N \cdot {( \frac{\partial V}{\partial N} )}_{PS} = ω + {( \frac{\partial S}{\partial N} )}_{TV} \cdot N \cdot {( \frac{\partial T}{\partial N} )}_{SV} + {( \frac{\partial P}{\partial N} )}_{VS} \cdot N \cdot {( \frac{\partial V}{\partial N} )}_{PS} & ( Eq . VI \text{-} 22 ) \\ 23. {Λ}_{VS} = {( \frac{\partial U}{\partial μ} )}_{VS} = {μ ( \frac{\partial N}{\partial μ} )}_{VS} = - {μ ( \frac{{\partial }^{2} Ψ}{\partial {μ}^{2}} )}_{VS} = \frac{μ \cdot ( - N )}{{Γ}_{VS}} = \frac{- μ N}{ω + {( \frac{\partial S}{\partial N} )}_{TV} \cdot N \cdot {( \frac{\partial T}{\partial N} )}_{SV}} & ( Eq . VI \text{-} 23 ) \\ 24. {Λ}_{PS} = {( \frac{\partial H}{\partial μ} )}_{PS} = {μ ( \frac{\partial N}{\partial μ} )}_{PS} = - {μ ( \frac{{\partial }^{2} χ}{\partial {μ}^{2}} )}_{PS} = \frac{μ \cdot ( - N )}{{Γ}_{PS}} = \frac{- μ N}{ω + {( \frac{\partial S}{\partial N} )}_{TV} \cdot N \cdot {( \frac{\partial T}{\partial N} )}_{SV} + {( \frac{\partial P}{\partial N} )}_{VS} \cdot N \cdot {( \frac{\partial V}{\partial N} )}_{PS}} & ( Eq . VI \text{-} 24 )\end{matrix}$$

The above values of the twenty four C_{P}-type variables are very useful for us to obtain solutions of any other partial derivatives. Also the special values (0 and ∞) of some C_{P}-type variables (O_{Pμ}, J_{Tμ}, Γ_{PT} and C_{Pμ}, R_{Tμ}, Λ_{PT}) can help us to determine a specific geometrical symmetry by their locations in the diagrams for verifying the thermodynamic symmetry.

### VII. Verify Specific Symmetry in Thermodynamics

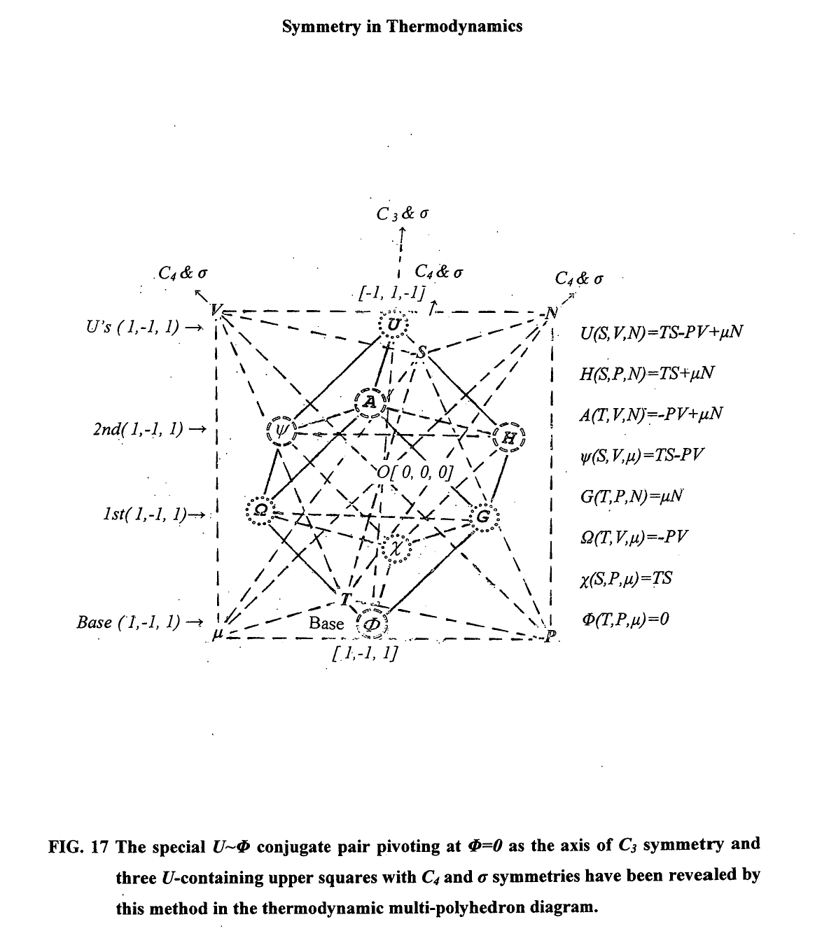

Thermodynamic symmetry was revealed by Koenig's works ^{[3, 4]}, where he resolved an important class of thermodynamic equations with ‘standard form’ into families, and summarized the numbers of members of the families being 48, 24, 12, 8, 6, 4, 3, and 1. His most results were graphically explained and verified in above descriptions. The remaining results could be geometrically explained and further verified by a well oriented cuboctahedron diagram in FIG. 17.

1. Six member family: A sample member, U−A+G−H=0, for this family is an equation to show us that sums of two variables at both ends of a pair of diagonals on any square (or face) of the cube are equal, i.e. (U+G)=(A+H). Therefore, there are 6 members of this family as there are 6 squares (or 6 faces) in the cube.

2. Four member family: A sample member, U−Φ=TS−PV+μN=U(S, V. N), for this family is an equation to show us that difference between a pair of the diagonal potentials in the cube is equal to the internal energy, U(S, V. N). It is true only for this special pair (U and Φ) because of Φ=0, and it is not true for other three members of the family since differences between other pair of the diagonal potentials in the cube are not equal to TS−PV+μN. For example, H−Ω=(TS+μN)−(−PV)=TS+PV+μN≠TS−PV+μN.

Therefore, the sample member of the four member family should be revised to become U+Φ=TS−PV+μN−U(S, V. N). The revised equation shows us that sum, rather than the difference, of any pair of the diagonal potentials in the cube is same, and equal to the internal energy of the system. This important equation may be used as a criterion for defining a conjugate pair of thermodynamic potentials, i. e. □+□*=TS−PV+μN=U(S, V, N). There are four members of this family because there are four diagonals in the cube or four conjugate pairs of the complete thermodynamic potentials.

3. Three member family: A sample member, U+A+G+H−χ−Φ−Ω−ψ=4 μN, is an equation to show us that difference between two sums of four variables on upper square (U+A+G+H) and on its parallel lower square (χ+Φ+Ω+ψ) is four times larger than product of a pair of conjugate natural variables (μ and N), which are parallel to the normal of two parallel squares in the cube. There are 3 members of this family because there are only 3 pairs of parallel squares in the cube.

4. One member family: A sample member, U−A+G−H+χ−Φ+Ω−ψ=0, is an equation to show us that for a pair of conjugate thermodynamic potentials (U˜Φ) the sum of a thermodynamic potential (U) with its second neighbors in the cube (U+G+χ+Ω) equals the sum of its conjugate thermodynamic potential (Φ) with its second neighbors in the cube (Φ+A+H+ψ). This relation is true not only for the U˜Φ pair, but also for other three conjugate pairs (A˜χ, G˜Ψ, and H˜Ω) since the sum of any potential with its three second neighbor potentials equals to 2U in the cube, therefore this equation is not suitable to be the sample member of the one member family.

The sample member of the one member family should be revised to be the previously mentioned equation: U−Φ=TS−PV+μN=U(S, V, N), since it is true only for a special conjugate pair (U and Φ) that difference between two diagonal potentials in the cube equals the internal energy, U(S, V. N) because of Φ(T, P, μ)=0.

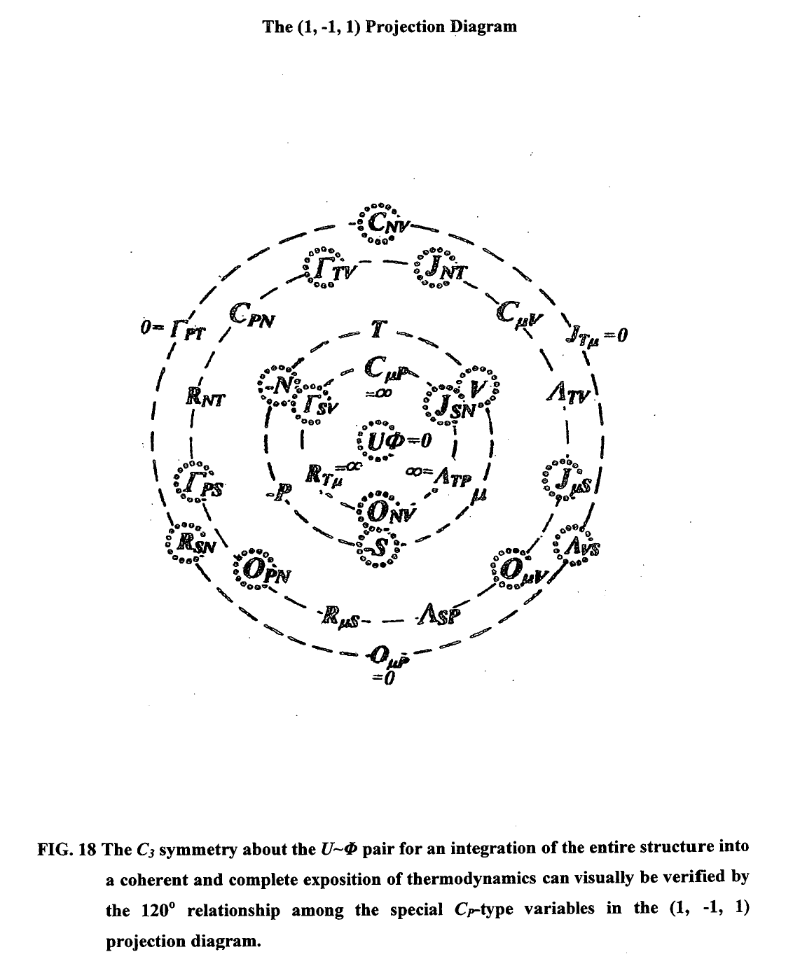

It has been verified by above descriptions that symmetry in thermodynamics exhibits only one C₃ symmetry about the special conjugate ‘U˜Φ’ pair, and C₄ and σ symmetries on three U-containing squares, where the square of U, H, G and A is most important and useful. Such a conclusion can also be verified by a relationship of 120° separating each other among three zero-value C_{P} type variables (O_{Pμ}, J_{Tμ}, Γ_{PT}) and three infinite-value C_{P} type variables (C_{Pμ}, R_{Tμ}, Λ_{PT}) shown on the (1, −1, 1) diagram (FIG. 18), where the six first and twenty four second order partial derivative variables were parallel projected along the special U˜Φ pair's direction, i. e. [1, −1, 1] direction, on the (1, −1, 1) plane.

### VIII. Derive any Desired Partial Derivatives

Any desired partial derivatives,

$${( \frac{\partial X}{\partial Y} )}_{ZW} ,$$

can graphically be derived on the spot by this method like getting any destinations on a map. It is entirely foolproof. Two examples are shown below.

$$\begin{matrix}Example 1 \text{:} {( \frac{\partial A}{\partial P} )}_{SN} = ? \\ Solution \text{:} {( \frac{\partial A}{\partial P} )}_{SN} = {( \frac{\partial ( G + V \cdot ( - P ) )}{\partial P} )}_{SN} = {( \frac{\partial ( H + T \cdot ( - S ) + V \cdot ( P ) )}{\partial P} )}_{SN} ( Using Pattern 1 ) = {( \frac{\partial H}{\partial P} )}_{SN} - {S ( \frac{\partial T}{\partial P} )}_{SN} - {P ( \frac{\partial V}{\partial P} )}_{SN} - V = V - {S ( \frac{\partial V}{\partial S} )}_{PN} - {P ( \frac{\partial V}{\partial P} )}_{SN} - V ( Using Pattern 2 \& 3 ) = - {S ( \frac{\partial V}{\partial T} )}_{PN} {( \frac{\partial T}{\partial S} )}_{SN} - P ( \frac{{R}_{SN}}{( - P )} ) - S ( α V ) ( \frac{{O}_{PN}}{( - S )} ) + {R}_{SN} ( Using ' α ' \& Patterns 8 ) = α {VO}_{PN} + {R}_{SN} + α V ( \frac{- TS}{{C}_{PN}} ) + ( {κ}_{T} PV - \frac{{α}^{2} {V}^{2} PT}{{C}_{PN}} ) ( Using Patterns 10 \& 11 = {κ}_{T} PV - ( \frac{{α}^{2} {V}^{2} PT + α VTS}{{C}_{PN}} ) and {O}_{PN} \& {R}_{SN} ' s values ) . & 1 \\ Example 2 \text{:} {( \partial G )}_{U} = J ( G , U ) = ? \\ Solution \text{:} {( \partial G )}_{U} = J ( G , U ) = ( - S ) \cdot J ( T , U ) + ( V ) \cdot J ( P , U ) ( Using Pattern 12 ) = S \cdot J ( U , T ) - V \cdot J ( U , P ) Since J ( x , y ) = - J ( y , x ) ) where , J ( U , T ) = \frac{J ( U , T )}{J ( T , P )} = \frac{\partial ( U , T )}{\partial ( T , P )} = - \frac{\partial ( U , T )}{\partial ( P , T )} = - {( \frac{\partial U}{\partial P} )}_{T} ( Let J ( T , P ) = 1 ) - {\{ \frac{\partial ( H + V \cdot ( - P ) )}{\partial P} \}}_{T} = - {\{ \frac{\partial ( G + S \cdot ( T ) + V \cdot ( - P ) )}{\partial P} \}}_{T} ( Using Pattern 1 ) = - \{ {( \frac{\partial G}{\partial P} )}_{T} + {T ( \frac{\partial S}{\partial P} )}_{T} - V - {P ( \frac{\partial V}{\partial P} )}_{T} \} ( Using Pattern 2 ) = - \{ V - T {( \frac{\partial V}{\partial T} )}_{P} - V - {P ( \frac{\partial V}{\partial P} )}_{T} \} ( Using Pattern 3 ) = {T ( \frac{\partial V}{\partial T} )}_{P} + {P ( \frac{\partial V}{\partial P} )}_{T} and J ( U , P ) = \frac{J ( U , P )}{J ( T , P )} = \frac{\partial ( U , P )}{\partial ( T , P )} = {( \frac{\partial U}{\partial T} )}_{P} ( Let J ( T , P ) = 1 ) = {\{ \frac{\partial ( H + V \cdot ( - P ) )}{\partial T} \}}_{P} = {\{ \frac{\partial ( G + S \cdot ( T ) + V \cdot ( - P ) )}{\partial T} \}}_{P} ( Using Pattern 1 ) = \{ {( \frac{\partial G}{\partial T} )}_{P} + S + {T ( \frac{\partial S}{\partial T} )}_{P} - {P ( \frac{\partial V}{\partial T} )}_{p} \} ( Using Pattern 2 ) = \{ S + S + T ( \frac{{C}_{P}}{( T )} ) - {P ( \frac{\partial V}{\partial T} )}_{P} \} ( Using Patterns 8 ) = {C}_{P} - {P ( \frac{\partial V}{\partial T} )}_{P} & 2\end{matrix}$$

Finally substitute the results of J(U, T) and J(U, P) into following equation:

$${( \partial G )}_{U} = J ( G , U ) = ( - S ) \cdot J ( T , U ) + ( V ) \cdot J ( P , U ) = S \cdot J ( U , T ) - V \cdot J ( U , P ) = S \cdot \{ {T ( \frac{\partial V}{\partial T} )}_{P} + {P ( \frac{\partial V}{\partial P} )}_{T} \} - V \cdot \{ {C}_{P} - {P ( \frac{\partial V}{\partial T} )}_{P} \} = - {VC}_{P} + {PV ( \frac{\partial V}{\partial T} )}_{P} + {ST ( \frac{\partial V}{\partial T} )}_{P} + {SP ( \frac{\partial V}{\partial P} )}_{T}$$

(Note: This example is one of the Bridgman's thermodynamic equations ^{[5]}.)

Solutions of seventy two partial derivatives are given in Table 1 below for user's convenience.

TABLE 1
Solutions for seventy two partial derivatives^{[7]}

| No | X | Y | Z | (∂X/∂Y)_{Z} | No | X | Y | Z | (∂X/∂Y)_{Z} |
|---|---|---|---|---|---|---|---|---|---|
| 1 | V | T | P | αV | 2 | S | T | P | C_{P}/T |
| 3 | U | T | P | C_{P} − αPV | 4 | H | T | P | C_{P} |
| 5 | A | T | P | −αPV − S | 6 | G | T | P | −S |
| 7 | P | T | V | α/κ_{T} | 8 | S | T | V | C_{P}/T − α²V/κ_{T} |
| 9 | U | T | V | C_{P} − (α²VT/κ_{T}) | 10 | H | T | V | C_{P} − (α²VT/κ_{T}) + αV/κ_{T} |
| 11 | A | T | V | −S | 12 | G | T | V | (αV/κ_{T}) − S |
| 13 | P | T | S | C_{P}/αVT | 14 | V | T | S | αV − (κ_{T}C_{P}/αT) |
| 15 | U | T | S | (κ_{T}C_{P}P/αT) − αPV | 16 | H | T | S | C_{P}/αT |
| 17 | A | T | S | (κ_{T}C_{P}P/αT) − αPV − S | 18 | G | T | S | (C_{P}/αT) − S |
| 19 | V | P | T | −κ_{T}V | 20 | S | P | T | −αV |
| 21 | U | P | T | κ_{T}PV − αVT | 22 | H | P | T | V − αVT |
| 23 | A | P | T | κ_{T}PV | 24 | G | P | T | V |
| 25 | T | P | S | αVT/C_{P} | 26 | V | P | S | −κ_{T}V + (α²V²T/C_{P}) |
| 27 | U | P | S | κ_{T}PV − (α²V²PT/C_{P}) | 28 | H | P | S | V |
| 29 | A | P | S | κ_{T}PV − (α²V²PT/C_{P}) − (αVTS/C_{P}) | 30 | G | P | S | V − (αVTS/C_{P}) |
| 31 | T | P | V | κ_{T}/α | 32 | S | P | V | (κ_{T}C_{P}/αT) − αV |
| 33 | U | P | V | (κ_{T}C_{P}/α) − αVT | 34 | H | P | V | (κ_{T}C_{P}/α) − αVT + V |
| 35 | A | P | V | −κ_{T}S/α | 36 | G | P | V | V − (κ_{T}S/α) |
| 37 | P | V | T | −1/κ_{T}V | 38 | S | V | T | α/κ_{T} |
| 39 | U | V | T | (αT/κ_{T}) − P | 40 | H | V | T | (αT/κ_{T}) − 1/κ_{T} |
| 41 | A | V | T | −P | 42 | G | V | T | −1/κ_{T} |
| 43 | T | V | S | αT/(α²VT − κ_{T}C_{P}) | 44 | P | V | S | C_{P}/(α²V²T − κ_{T}C_{P}V) |
| 45 | U | V | S | −P | 46 | H | V | S | C_{P}/(α²VT − κ_{T}C_{P}) |
| 47 | A | V | S | (αTS/(κ_{T}C_{P} − α²VT)) − P | 48 | G | V | S | (C_{P} − αTS)/(α²VT − κ_{T}C_{P}) |
| 49 | T | V | P | 1/αV | 50 | S | V | P | C_{P}/αVT |
| 51 | U | V | P | (C_{P}/αV) − P | 52 | H | V | P | C_{P}/αV |
| 53 | A | V | P | (−S/αV) − P | 54 | G | V | P | −S/αV |
| 55 | T | S | V | κ_{T}T/(κ_{T}C_{P} − α²VT) | 56 | P | S | V | αT/(κ_{T}C_{P} − α²VT) |
| 57 | U | S | V | T | 58 | H | S | V | T + (αVT/(κ_{T}C_{P} − α²VT)) |
| 59 | A | S | V | κ_{T}ST/(α²VT − κ_{T}C_{P}) | 60 | G | S | V | (αVT − κ_{T}ST)/(κ_{T}C_{P} − α²VT) |
| 61 | T | S | P | T/C_{P} | 62 | V | S | P | αVT/C_{P} |
| 63 | U | S | P | T − (αVTP/C_{P}) | 64 | H | S | P | T |
| 65 | A | S | P | (−ST/C_{P}) − (αVTP/C_{P}) | 66 | G | S | P | −ST/C_{P} |
| 67 | P | S | T | −1/αV | 68 | V | S | T | κ_{T}/α |
| 69 | U | S | T | T − (κ_{T}P/α) | 70 | H | S | T | T − (1/α) |
| 71 | A | S | T | −κ_{T}P/α | 72 | G | S | T | −1/α |

### IX. Conclusions

1. A variety (forty four) of thermodynamic variables are properly arranged in an extended concentric multi-polyhedron diagram based on their physical meanings.
2. Numerous (more than three hundreds) thermodynamic equations can concisely be depicted by overlapping specific movable graphical patterns on fixed diagrams through symmetrical operations. Three kinds of Maxwell-like partial derivatives can easily be distinguished by their patterns. Any desired partial derivatives can graphically be derived in terms of several available quantities like getting any destinations on a map.
3. Symmetry in thermodynamics is not as perfect as the geometrical symmetry. It consists of only one C₃ symmetry about the special conjugate ‘U˜Φ’ pair, and C₄ and σ symmetries on three U-containing squares.
4. The elegant 3-D diagram (FIG. 1), which provides a coherent and complete structure of thermodynamic variables, might be considered as ‘a model’, rather than a mnemonic device, since it profoundly represents symmetrical thermodynamics. It has much common with the Periodic Table of the Elements in chemistry and the Eightfold Way pattern in particle physics.

### X. References

1. Herbert Callen, ‘Thermodynamics as a Science of Symmetry’, Foundations of Physics, Vol. 4, No. 4, pp. 423˜443 (1974).
2. Herbert B. Callen, Thermodynamics and An Introduction to Thermostatistics', 2nd Edition, 131, 458 (1985).
3. F. O. Koenig, ‘Families of Thermodynamic Equations. I—The Method of Transformations by the Characteristic Group’, J. Chem. Phys., 3, 29 (1935).
4. F. O. Koenig, ‘Families of Thermodynamic Equations. II The Case of Eight Characteristic Functions’, J. Chem. Phys., 56, 4556 (1972).
5. J. A. Prins, ‘On the Thermodynamic Substitution Group and Its Representation by the Rotation of a Square’, J. Chem. Phys., 16, 65 (1948).
6. R. F. Fox, ‘The Thermodynamic Cuboctahedron’, J. Chem. Edu., 53, 441 (1976).
7. Zhenchuan Li, ‘A Study of Graphic Representation of Thermodynamic State Function Relations’, HUAXUE TONGBAO (Chemistry) in Chinese, 1982, No. 1, pp. 48-55 (1982) & Chemical Abstract, 96, 488. 96: 188159t (1982).
8. S. F. Pate, ‘The thermodynamic cube: A mnemonic and learning device for students of classic thermodynamics’, Am. J. Phys., 67(12), 1111 (1999).
9. W. C. Kerr and J. C. Macosko, ‘Thermodynamic Venn diagram: Sorting out force, fluxes, and Legendre transforms’, Am. J. Phys., 79 (9), 950-953, (2011).
10. Z. C. Li and S. H. Whang, ‘Planar defects in {113} planes of L1ₒ type TiAl—Their structures and energies’, Phil. Mag., A, 1993, Vol. 68, No. 1, 169-182.
11. Joe Rosen, Symmetry in Science, 97 (1995).
12. Robert A. Alberty, ‘Use of Legendre Transforms in Chemical Thermodynamics’, Pure Appl. Chem., 73 (8), 1350 (2001)
13. F. H. Crawford, ‘Jacobian Methods in Thermodynamics’, Am. J. Phys., 17 (1),1 (1949).
14. Charles E. Reid, Principles of Chemical Thermodynamics, 36 & 249, Reinhold, New

York (1960).
15. P. W. Bridgman, Phys. Rev., 2^{nd} series, 3, 273 (1914).

What is claimed is:

1. A symmetry graphical method in thermodynamics, comprising:
all members or equations of twelve thermodynamic families in a single component one-phase system are concisely depicted one by one by overlapping specifically created movable graphical patterns on fixed {1, 0, 0} diagrams through symmetrical operations based on the equivalence principle of symmetry.

2. The symmetry graphical method in thermodynamics of claim 1, wherein said {1, 0, 0} diagrams are resolved and projected from an extended concentric multi-polyhedron diagram for user's convenience.

3. The symmetry graphical method in thermodynamics of claim 2, wherein said extended concentric multi-polyhedron is consists of a cube sandwiching in between two octahedrons and a rhombicuboctahedron surrounding them, and forty four vertices of said extended concentric multi-polyhedron are properly occupied by a variety of thermodynamic variables, such as natural variables, thermodynamic potentials, and first and second partial derivatives of the thermodynamic potentials, based on their physical meanings.

4. The symmetry graphical method in thermodynamics of claim 3, wherein twenty four vertices of said rhombicuboctahedron are occupied by C_{PN}, C_{VN}, and twenty two symmetrically invented C_{PN} type variables, such as O_{PN}, O_{VN}, J_{TN}, J_{SN}, R_{TN}, R_{SN}, C_{Pμ}, C_{Vμ}, O_{Pμ}, O_{Vμ}, J_{Tμ}, J_{Sμ}, R_{Tμ}, R_{Sμ}, Λ_{PT}, Λ_{VT}, Γ_{PT}, Γ_{VT}, Λ_{PS}, Λ_{VS}, Γ_{PS}, and Γ_{VS}.

5. The symmetry graphical method in thermodynamics of claim 4, whereby said symmetry in thermodynamics is revealed and verified to be a special U˜Φ conjugate pair pivoting at Φ=0 as the axis of C₃ symmetry and three U-containing upper squares with C₄ and σ symmetries.

6. The symmetry graphical method in thermodynamics of claim 5, wherein said equivalence principle of symmetry, i.e. reproducibility and predictability, is generalized to become a general procedure of four steps described.

7. The symmetry graphical method in thermodynamics of claim 6, wherein twelve specific graphical patterns are created for said twelve thermodynamic families respectively.

8. The symmetry graphical method in thermodynamics of claim 7, whereby said specific graphical patterns not only enable to classify different equations into said twelve families and to distinguish some quite confused similar partial derivatives into different families, such as Patterns 2, 3, 4, 7 and 8, but also enable to develop novel C_{PN}-type variables and novel members of the Gibbs-Holmholtz equation's family and to establish novel relations among said twenty four C_{PN} type variables.

9. The symmetry graphical method in thermodynamics of claim 8, whereby solutions of any desired partial derivatives are graphically derived in terms of several available quantities on the spot like getting any desired destinations on a map.

10. The symmetry graphical method in thermodynamics of claim 9, whereby some of said solutions, such as that of seventy two partial derivatives and twenty two novel C_{PN}-type variables, are given for user's convenience.

11. The symmetry graphical method in thermodynamics of claim 10, wherein three unnamed thermodynamic potentials Φ(T, P, μ), ψ(S, V, μ), and χ(S, P, μ) are meaningfully named to be conjugate potentials with respect to U(S, V, N), G(T, P, N), and A(T, V, N) respectively, based on the fact that sum of any pair of the diagonal potentials in the cube is same and equals the internal energy of the system, i.e. □+□*=TS−PV+μN=U(S, V, N).

12. The symmetry graphical method in thermodynamics of claim 11, whereby said extended concentric multi-polyhedron, as a model, exhibits an integration of the entire structure into a symmetrical, coherent and complete exposition of thermodynamics.
